(19) United States
(12) Patent Application Publication
(10) Pub. No.: US 2014/0223572 A1
(43) Pub. Date: Aug. 7, 2014

(54) MESSAGE SERVICE PROVIDING METHOD, AND APPARATUS AND SYSTEM THEREFOR

(71) Applicant: SK Planet Co., Ltd., Seongnam-si, Gyeonggi-do (KR)

(72) Inventor: Hai Gang Roh, Seongnam-si (KR)

(21) Appl. No.: 14/241,310

(22) PCT Filed: Jul. 15, 2013
(86) PCT No.: PCT/KR2013/006318

§ 371 Date: Feb. 26, 2014

(30) Foreign Application Priority Data
Jul. 31, 2012 (KR) 10-2012-0084051
Aug. 2, 2012 (KR) 10-2012-0084775
Aug. 6, 2012 (KR) 10-2012-0085535
Aug. 20, 2012 (KR) 10-2012-0090609

(51) Int. Cl. H04L 29/06; G06F 17/22

(52) U.S. Cl. CPC H04L 63/04; G06F 17/2235
USPC 726/26

(57) ABSTRACT

The present invention relates to a message service providing method, and more specifically, to a message service providing method, and an apparatus and a system therefor capable of selective message protection by extracting a part corresponding to confidential information when the confidential information is included in a message received from a partner, and setting a protection function for only the extracted part.

A message service providing system according to an embodiment of the present invention for this includes a message service providing apparatus which determines whether confidential information is included in a received message when the message is received from a user terminal apparatus, extracts a part corresponding to the confidential information from the received message when the confidential information is included, sets a protection function for only the extracted part, and transmits the message in which the protection function has been set to a partner terminal apparatus.

### TECHNICAL FIELD

The present invention relates to a message service providing method, and more specifically, to a message service providing method, and an apparatus and a system therefor capable of selective message protection by extracting a part corresponding to confidential information when the confidential information is included in a message received from a partner, and setting a protection function for only the extracted part.

Further, the present invention relates to a message service providing method, and more specifically, to a message service providing method and an apparatus and a system therefor which extract link information for an attached file received through a messenger service, manage the link information as a file list, and provide an attached file related to specific link information selected from the file list.

Further, the present invention relates to a message service providing method, and more specifically, to a message service providing method and an apparatus and a system therefor which enable a user to more easily recognize content of a message by analyzing a message transmitted or received among a plurality of terminals according to previously set analysis items, calculating a statistic result in various points of view, and providing the statistic result to the user.

Further, the present invention relates to a message service providing method, and more specifically, to a message service providing method and an apparatus and a system therefor which are capable of providing comment information for specific terms included in a transmitted or received message.

### BACKGROUND ART

With the rapid development of information and communication technology, various types of terminals such as mobile communication terminals or personal computers may be implemented to be able to perform various functions. For example, in a mobile communication terminal, in addition to a basic voice communication function, various recent functions such as data communication, recording of photographs and videos using a camera, reproduction of music or video files, gaming, and viewing of broadcasting programs are implemented in combination.

Technology development for improvement of functions that can be executed in such terminals is continuously performed, and both hardware enhancement technology are software enhancement technology continue to be mainly developed.

Meanwhile, recently, a use frequency of SMS messages and messenger programs which enable users to access a communication network and then carry on a conversation with other users continuously increases.

However, in current SMS message services and messenger programs, there is a problem of direct exposure of information related to privacy of a user when the user is exposed to a complex external environment by merely directly outputting a message received from a partner or a message input by a user.

### SUMMARY OF INVENTION

### Technical Problem

The present invention has been proposed to solve the above-described conventional problems and an object of the present invention is to provide a message service providing method, and an apparatus and a system therefor capable of extracting a part corresponding to confidential information when the confidential information is included in a message received from a partner, and setting a protection function for only the extracted part.

Another object of the present invention is to provide a message service providing method, and an apparatus and a system therefor capable of extracting a part corresponding to confidential information together according to set regular information when the confidential information according to a user setting is included in a message, and setting a protection function for only the extracted part.

Still another object of the present invention is to provide a message service providing method, and an apparatus and a system therefor capable of extracting a part corresponding to confidential information when the confidential information is included in a message, and differently setting a protection function for the extracted part according to a previously set protection function applying criterion.

Still another object of the present invention is to provide a message service providing method, and an apparatus and a system therefor capable of extracting link information for an attached file received through a messenger service, managing the link information as a file list, and providing an attached file related to specific link information selected from the file list.

Still another object of the present invention is to provide a message service providing method, and an apparatus and a system therefor capable of analyzing a message transmitted or received among a plurality of terminals according to previously set analysis items, calculating various statistic results, and providing the statistic results to a user.

Still another object of the present invention is to provide a message service providing method, and an apparatus and a system therefor capable of allowing content of a conversation to be more easily recognized and allowing content of a conversation of previous users to be clearly recognized even upon late participation in the conversation by analyzing a message transmitted or received among a plurality of terminal apparatuses and providing an analysis result to a user.

Still another object of the present invention is to provide a message service providing method, and an apparatus and a system therefor in a message service environment which perform support so that normal verbal communication can be realized by providing, as comment information, a description through which a recipient can understand specific content in content of a message.

### Solution to Problem

A message service providing system of the present invention for achieving the object as described above may include: a message service providing apparatus which determines whether confidential information is included in a received message when the message is received from a user terminal apparatus, extracts a part corresponding to the confidential information from the received message when the confidential information is included, sets a protection function for only the extracted part, and transmits the message in which the protection function has been set to a partner terminal apparatus; and a terminal apparatus which transmits an input message to the message service providing apparatus when the message is input by a user, requests the user to input a password when the message in which the protection function has been set is received from the message service providing apparatus, and releases the protection function to display the message when the password is input by the user and the input password matches a previously set password.

A terminal apparatus of the present invention for achieving the object as described above may include: a communication unit which transmits or receives a message; and a control unit which determines whether confidential information is included in the message, extracts a part corresponding to the confidential information from the message when the confidential information is included, and sets a protection function for only the extracted part.

Here, when the protection function is set to be applied based on any one of line units, phrase units, and syllable units, the control unit may perform control to apply the protection function to a line, a phrase, or a syllable including the extracted part after extracting the part corresponding to the confidential information from the received message.

Further, the control unit may adjust shade, color, lightness and screen brightness of an area corresponding to the extracted part or adjust a size of a character corresponding to the extracted part to set the protection function.

Further, the control unit may display the message in which the protection function has been set, display a password input window through which a password is able to be input by a user in response to a request of the user, and release the protection function to display the message when the password is input by the user through the password input window and the input password matches a previously set password.

A message service providing apparatus of the present invention for achieving the object as described above may include: a service communication unit which transmits or receives information to or from a terminal apparatus; and a service control unit which determines whether confidential information is included in a received message when the message is received from any one user terminal apparatus, extracts a part corresponding to the confidential information from the received message when the confidential information is included, sets a protection function for only the extracted part, transmits the message in which the protection function has been set to a partner terminal apparatus.

Here, the service control unit may confirm a previously set regular information corresponding to the confidential information and extract an entire part corresponding to the regular information.

A message service providing system of the present invention for achieving the object as described above may include: a terminal apparatus which requests a service apparatus to provide a file list for an attached file received from at least one other terminal apparatus during use of a messenger service, receives the file list from the service apparatus according to the request, selects an attached file from the received file list, requests the service apparatus to transmit the selected attached file, receives the attached file according to the request, and outputs the received attached file; and a message service providing apparatus which provides a messenger service among a plurality of terminal apparatuses, confirms an attached file transmitted from at least one terminal apparatus using the messenger service, generates link information related to the confirmed attached file, stores the generated link information in a file list, transmits the file list in response to a request of the terminal apparatus, confirms the link information for the attached file selected from the file list, searches for the attached file corresponding to the confirmed link information, and transmits the attached file to the terminal apparatus.

A terminal apparatus of the present invention for achieving the object as described above may include: a communication unit which communicates with a plurality of terminal apparatuses and a message service providing apparatus to transmit or receive data for execution of a messenger service; and a control unit which performs control to request the message service providing apparatus to provide a file list for at least one attached file received from at least one other terminal apparatus during use of the messenger service, receive the file list from the message service providing apparatus according to the request, select at least one attached file from the received file list, request the message service providing apparatus to transmit the selected attached file, receive the attached file according to the request, and output the received attached file.

Here, the terminal apparatus may further include a storage unit which stores the attached file received from at least one other terminal apparatus during use of the messenger service, and a file list including link information of the attached file.

Further, the control unit may receive the attached file from at least one other terminal apparatus during use of the messenger service, generate link information related to the received attached file, store the generated link information as a file list, presents the file list in response to a request of a user during use of the messenger service, confirm the link information selected from the file list, read an attached file corresponding to the confirmed link information, and output the read attached file.

Further, the control unit may output information for the attached file in a partial area or a previously set screen position of the messenger service execution screen.

Further, the control unit may display an attached file menu in response to a request of the user during use of the messenger service, present a file list for an attached file attached during conversation or previously when the attached file menu is selected, and output a specific file selected from the file list.

A message service providing apparatus of the present invention for achieving the object as described above may include: a service communication unit which communicates with a plurality of terminal apparatuses to transmit or receive data for providing a messenger service; a service storage unit which stores an attached file received from at least one terminal apparatus during use of the messenger service, and a file list including link information of the attached file; and a service control unit which perform control to provide the messenger service among a plurality of terminal apparatuses, confirm an attached file transmitted from at least one terminal apparatus using the messenger service, generate link information related to the confirmed attached file, store the generated link information as a file list, transmit the file list in response to a request of the terminal apparatus, confirm the link information for the attached file selected from the file list, search for the attached file corresponding to the confirmed link information, and output the attached file to the terminal apparatus.

Here, the service control unit may compress the received attached file, classify the attached file in conversation window units or in conversation partner units, and store the compressed attached file and the link information to be matched according to the classification unit.

Here, the attached file may include at least one of a document file, a music file, a video file, and URL information received from at least one terminal apparatus during use of the messenger service.

Here, the link information may identify each attached file, and include at least one information of a file name, a file size, an extension and a file format of the attached file.

A message service providing system of the present invention for achieving the object as described above may include: a terminal apparatus which transmits or receives a message in a state in which a conversation channel with at least one partner terminal apparatus is established, requests a message service providing apparatus to analyze a message transmitted or received through the conversation channel, and receives a statistic result for the message from the message service providing apparatus; and the message service providing apparatus which receives and stores a message transmitted or received through at least one conversation channel, analyzes the message transmitted or received through the conversation channel to date according to previously set analysis items to calculate statistics when an analysis request for a message is received from any one terminal apparatus participating in the conversation channel, and transmits the calculated statistic result to the terminal apparatus.

A message service providing system of the present invention for achieving the object as described above may include: one or more terminal apparatuses which transmit or receive a message and output comment information for one or more terms included in the message together with the message; and a message service providing apparatus which compares personal information of a sender and a recipient of the message to confirm a difference in culture between the sender and the recipient, collects comment information for one or more terms included in the message based on the confirmed culture difference, and provide the collected comment information to the terminal.

A message service providing apparatus of the present invention for achieving the object as described above may include: a service communication unit which communicates with one or more terminal apparatuses; a service storage unit which stores a comment information database which defines one or more meanings of one or more terms; and a service control unit which performs control to compare personal information of a sender and a recipient of a message transmitted or received by the plurality of terminal apparatuses to confirm a difference in culture between the sender and the recipient, search for the comment information database based on the confirmed culture difference to refer to neighboring terms of one or more terms included in the message, confirm a category corresponding to the term, collect comment information corresponding to the category from the comment information database, and provide the collected comment information to the terminal apparatus.

Here, the service control unit may collect at least one of a specific term and an adjacent neighboring term in content in which the specific term is arranged from the message content, and collect comment information based on an upper category for the specific term and a lower category of the adjacent terms.

### Advantageous Effects of Invention

According to the message service providing method, and an apparatus and a system therefor of the present invention, there is an advantage that protection of the message can be realized selectively by setting a protection function for only the part corresponding to the confidential information when the confidential information is included in the received message from the partner.

According to the message service providing method, and an apparatus and a system therefor of the present invention, there is an advantage that efficiency of the message information protection method can be improved by applying the protection function in consideration of all of various rules in response to the confidential information according to the user setting.

According to the message service providing method, and an apparatus and a system therefor of the present invention, there is an advantage that the user can organically set protection information of the message by differently setting the protection function according to the user setting.

Further, according to the present invention, since the listed link information of the attached file is selected to access the attached file without scrolling through a conversation window during a messenger service to search for and execute the attached file, the attached file can be easily confirmed.

Further, since the attached files received during a conversation using the messenger service are classified in conversation units or conversation partner units and stored, management of the attached files can be performed effectively.

Further, according to the present invention, there is an advantage that messages transmitted or received among a plurality of users can be analyzed according to the previously set analysis items and then various statistical results can be provided to the user.

Further, according to the present invention, there is an advantage that the user can clearly confirm content of the conversation by analyzing messages transmitted or received among a plurality of users according to the previously set analysis items.

Further, according to the present invention, there is an advantage that a late participant in a conversation can more easily recognize content of the conversation of previous users by analyzing messages transmitted or received to date among a plurality of terminals from various points of view and providing an analysis result.

Further, according to the present invention, it is possible to perform support so that a user can understand content of a transmitted or received message more quickly and exactly by providing comment information for specific content of a message.

Further, as the present invention is applied to jargon, informal language, or slang, it is possible to perform support to assist in understanding appropriate content of a message while supporting faster and quicker message service use by increasing a degree of understanding of content including specific terms frequently used at the time of use of the message service.

### BRIEF DESCRIPTION OF DRAWINGS

FIG. 1 is a schematic configuration diagram of a message service providing system according to an embodiment of the present invention.

FIG. 2 is a block diagram illustrating a main configuration of a terminal apparatus according to an embodiment of the present invention illustrated in FIG. 1.

FIGS. 3 to 5 are illustrative diagrams of a screen illustrating a protection function applying criterion.

FIG. 6 is a block diagram illustrating a main configuration of the message service providing apparatus according to an embodiment of the present invention illustrated in FIG. 1.

FIG. 7 is an illustrative diagram of a screen illustrating a method of extracting a part corresponding to confidential information.

FIG. 8 is a diagram illustrating a configuration of a service control unit in greater detail in a configuration of the message service providing apparatus of the present invention.

FIG. 9 is a flowchart illustrating a message service providing method according to an embodiment of the present invention.

FIG. 10 is a flowchart illustrating a message service providing method according to another embodiment of the present invention.

FIG. 11 is a data flow diagram illustrating a method of managing an attached file in a messenger service according to an embodiment of the present invention.

FIG. 12 is a flowchart illustrating operation of a service apparatus according to an embodiment of the present invention.

FIG. 13 is a flowchart illustrating operation of a terminal according to an embodiment of the present invention.

FIG. 14 is a flowchart illustrating operation of a terminal according to another embodiment of the present invention.

FIG. 15 is a schematic flowchart illustrating a message service providing method according to an embodiment of the present invention.

FIG. 16 is a flowchart of a method of analyzing content of a message when a message analysis item is the number of times a message is input for each terminal.

FIG. 17 is a flowchart of a method of analyzing content of a message when the message analysis item is a total number of characters.

FIG. 18 is a flowchart of a method of analyzing content of a message when the message analysis item is popularity.

FIG. 19 is a flowchart of a method of analyzing content of a message when the message analysis item is kindness.

FIG. 20 is a flowchart of a method of analyzing content of a message when the message analysis item is a primary keyword.

FIGS. 21 and 22 are illustrative diagrams of a user interface illustrating a message service providing method according to an embodiment of the present invention.

FIG. 23 is a flowchart illustrating an example of a comment information providing method in the information providing service apparatus according to an embodiment of the present invention.

FIG. 24 is a flowchart illustrating another example of the comment information providing method in an information providing service apparatus according to an embodiment of the present invention.

FIG. 25 is a flowchart illustrating a method of providing comment information in a terminal according to an embodiment of the present invention.

FIG. 26 is an illustrative diagram of a screen which may be operated in a process of supporting a comment information service according to an embodiment of the present invention.

### DESCRIPTION OF EMBODIMENTS

Hereinafter, preferred embodiments in which those skilled in the art can easily implement the present invention will be described in detail with reference to the accompanying drawings. However, a concrete description of related well-known functions or configurations is omitted when it is determined that the gist of the present invention may be unnecessarily ambiguous in describing an operational principle of the preferred embodiments of the present invention in detail. This is intended to more definitely deliver a core of the present invention without making the core of the present invention ambiguous by omitting the unnecessary description. Further, terms like first and second used to describe various components are only used to distinguish one component from the other component, and not used to limit the components.

Further, parts having a similar function and operation are denoted with the same reference numbers throughout the drawings.

Further, a terminal apparatus of the present invention may be implemented in various forms. For example, a terminal apparatus described in this disclosure may be a stationary terminal such as a smart TV or a desktop computer, as well as a mobile terminal such as a smart phone, a tablet PC, a personal digital assistant (PDA), a portable multimedia player (PMP), or an MP3 Player. Any apparatus is applicable as a terminal apparatus of the present invention if it is a terminal apparatus capable of transmitting or receiving a message to or from other users through a communication network.

Further, in an embodiment of the present invention, a first terminal apparatus is a user terminal apparatus and a second terminal apparatus is a partner terminal apparatus, for convenience of description, but the present invention is not limited thereto and the second terminal apparatus may serve as the user terminal apparatus and the first terminal apparatus may serve as the partner terminal apparatus.

Hereinafter, a message service providing system according to an embodiment of the present invention will be described.

FIG. 1 is a schematic configuration diagram of a message service providing system according to an embodiment of the present invention.

Referring to FIG. 1, a message service providing system 100 of the present invention may include a plurality of terminal apparatuses 10, a message service providing apparatus 20, and a communication network 30.

When confidential information is included in a message transmitted or received between a first terminal apparatus 10a and a second terminal apparatus 10b, the message service providing system 100 of the present invention including such a configuration supports extracting a part corresponding to the confidential information and setting a protection function for only the extracted part.

Further, the confidential information in the present invention may be personal information which may be output on a screen, such as an account number, a phone number or an address, or specific keyword information according to a user setting such as “love” or “darling.”

Hereinafter, each component will be described in greater detail. The terminal apparatus 10 is a terminal apparatus which can transmit a message input by a user to a partner. For example, the terminal apparatus 10 transmits an input message to the message service providing apparatus 20 when the message is input by a user of the first terminal apparatus 10a and displays a message for which a protection function has been set through a display unit of the first terminal apparatus 10a when the message for which the protection function has been set is received from the message service providing apparatus 20 set.

In this case, when the user inputs a password to confirm the message, the first terminal apparatus 10a may determine whether the password matches a previously set password, and release the protection function and display the message only when the passwords match.

The message service providing apparatus 20 is an apparatus which supports a message information protection service according to an embodiment of the present invention. Particularly, when a message is received from a user terminal apparatus, e.g., the first terminal apparatus 10a, the message service providing apparatus 20 determines whether the previously set confidential information is included in the received message, extracts a part corresponding to the confidential information from the received message when the previously set confidential information is included in the received message, sets a protection function for only the extracted part, and then controls transmission of the resultant message to a partner terminal apparatus, e.g., the second terminal apparatus 10b.

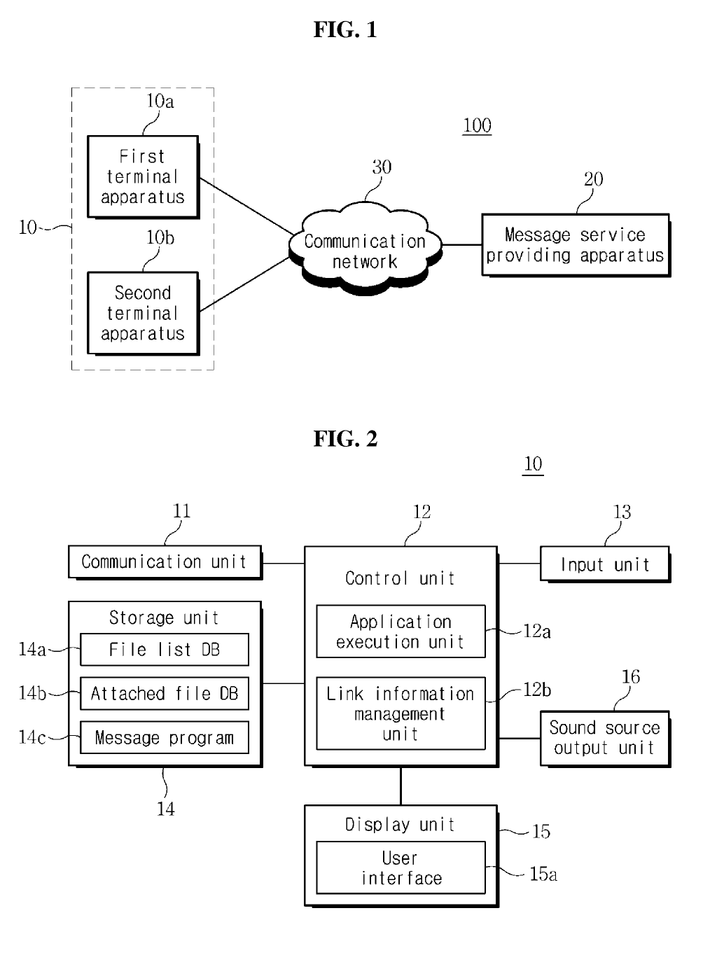

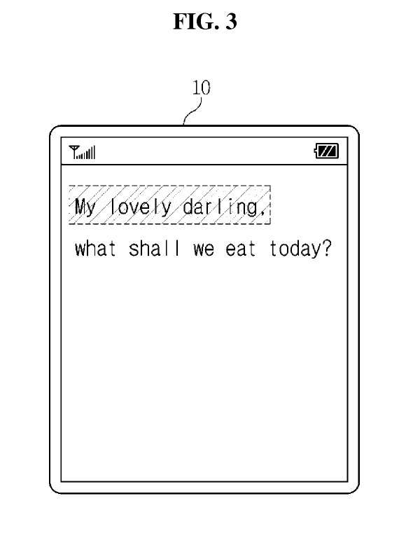

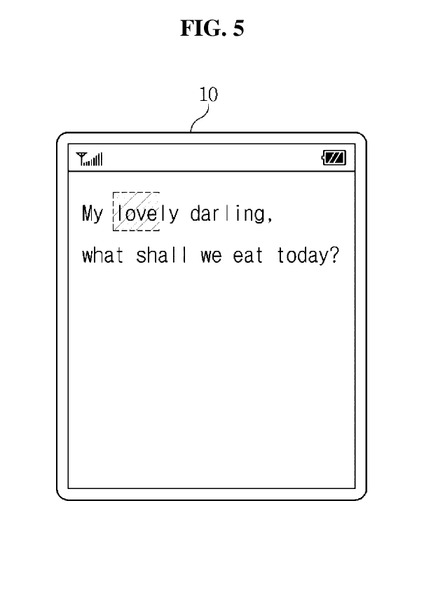

Main configurations and operation methods of the terminal apparatus 10 and the message service providing apparatus 20 will be described in greater detail with reference to FIGS. 2 and 5.

The plurality of terminal apparatuses 10 and the message service providing apparatus 20 according to an embodiment of the present invention transmit or receive various related pieces of information through the communication network 30. In this case, the communication network 30 may be any form of communication network.

For example, a wireless communication scheme such as a wireless LAN (WLAN), Wi-Fi, Wibro, Wimax or high speed downlink packet access (HSDPA) or a wired communication scheme such as Ethernet, xDSL (ADSL or VDSL), hybrid fiber coaxial cable (HFC), fiber to the curb (FTTC), or fiber to the home (FTTH) may be used.

Further, any other type of communication scheme that is well known or that will be developed in future may be included in addition to the communication schemes described above.

Further, in an embodiment of the present invention, an example in which the message service providing apparatus 20 determines whether the confidential information is included in the message transmitted or received between the terminal apparatuses 10, extracts a corresponding part when the confidential information is included, and sets the protection function for only the extracted part will be described, but the present invention is not limited thereto, and the terminal apparatus 10 may determine whether the confidential information is included in the message input by the user or the message received from the partner and perform the operation as describe above.

Meanwhile, in the message service providing system 100 according to an embodiment of the present invention, the terminal apparatus 10 transmits or receives data to provide the messenger service to or from the message service providing apparatus 20 through the communication network 30. Particularly, the terminal apparatus 10 according to the present invention requests the message service providing apparatus 20 to provide a file list for an attached file received from the terminal of the partner during use of the messenger service. Also, the terminal apparatus 10 receives the file list from the message service providing apparatus 20 and selects an attached file from the received file list. Also, the terminal apparatus 10 requests the message service providing apparatus 20 to transmit the selected attached file, receives the attached file according to the request, and outputs the attached file.

Further, the terminal apparatus 10 receives the attached file from the terminal apparatus of the partner during use of the messenger service and generates link information related to the received attached file. Also, the terminal apparatus 10 stores and manages the generated link information as a file list. Then, the terminal apparatus 10 presents the file list in response to the request of the user, and confirms link information to be selected from the presented file list. Also, the terminal apparatus 10 reads the attached file corresponding to the confirmed link information and outputs the read attached file.

The message service providing apparatus 20 communicates with the terminal apparatus 10 through the communication network 30 and transmits or receives data to provide the messenger service. Particularly, the message service providing apparatus 20 provides the messenger service among a plurality of terminal apparatuses. Also, the message service providing apparatus 20 confirms the attached file transmitted from a specific terminal apparatus using the messenger service, generates the link information related to the confirmed attached file and manages the link information as a file list.

The message service providing apparatus 20 transmits the file list in response to the request of the terminal apparatus 10 and confirms the link information for the attached file selected from the file list. Then, the message service providing apparatus 20 searches for the attached file corresponding to the confirmed link information, and transmits the attached file to the corresponding terminal.

Thus, according to the present invention, the attached file can be easily confirmed since the listed link information of the attached file is selected and the attached file is accessed without scrolling through a conversation window, searching for the attached file and executing the attached file during the messenger service. Further, management of the attached files can be effectively performed since attached files received during a conversation using the messenger service are classified and stored in conversation window units or conversation partner units.

Meanwhile, the message service providing system 100 according to an embodiment of the present invention performs support to analyze the message transmitted or received between the plurality of terminal apparatuses 10 connected through the conversation channel based on various analysis items, and provide a resultant statistic result to the terminal apparatus requesting message analysis.

Hereinafter, in an embodiment of the present invention, an example in which a statistic result for message analysis is provided to the terminal requesting message analysis will be described prior to a more concrete description of each component of the message service providing system 100, but the present invention is not limited thereto and the statistic result for message analysis may be provided to a plurality of terminal apparatuses 10 connected through the conversation channel

First, the terminal apparatus 10 supports transmission and reception of a message among a plurality of users. For example, the terminal apparatus 10 supports an entire process of transmitting a message to one or more second terminal apparatuses 10b connected to the conversation channel when the message is input by the user of the first terminal apparatus 10a, and receiving an input message and displaying the message on the first terminal apparatus 10a when the message is input from one or more second terminal apparatuses 10b.

Particularly, the terminal apparatus 10 according to an embodiment of the present invention may transmit or receive a message to or from a plurality of partner terminal apparatuses participating in the conversation channel, request the message service providing apparatus 20 to perform analysis of the message, and receive the statistic result for the analysis from the message service providing apparatus 20.

The message service providing apparatus 20 monitors and stores the message transmitted or received through at least one or more conversation channels. When the request for message analysis is received from any one terminal participating in the conversation channel, e.g., the first terminal apparatus 10a, the message service providing apparatus 20 performs a role of analyzing the message transmitted or received through the conversation channel to date according to previously set analysis items to calculate statistics and transmit the calculated statistic result to the first terminal apparatus 10a.

Meanwhile, in the message service providing system 100 according to an embodiment of the present invention, when the message service providing apparatus 20 receives a request to provide comment information for a specific term from the terminal apparatus 10, the message service providing apparatus 20 performs support to search for the comment information for the specific term and provide the comment information to the terminal apparatus 10. Accordingly, the terminal apparatus 10 can support understanding of terms which cannot be understood in content of the transmitted or received message.

Particularly, the message-related message service providing system 100 of the present invention can support providing of comment information specific to a message service by providing the comment information for the term described in the transmitted or received message. In this process, the message service providing system 100 in a message service environment provides appropriate comment information for terms used with different meanings from meanings on dictionaries, such as jargon, informal language, or slang, using information for neighboring terms described together with a term for which comment information is to be provided, thereby improving reliability of the comment information. Further, a difference in culture between a message sender and a message recipient may be confirmed based on personal information such as age, sex, occupation, nationality, educational background, religion or hobby, a term difficult for the recipient to understand based on the difference in culture may be extracted from among transmitted or received messages, and comment information for the extracted term may be provided. Here, the difference in culture refers to a difference in knowledge, beliefs and behaviors between persons, and refers to a difference in a field including one or more of age, language, religion, occupation, educational background, nationality, sex, and hobby.

The communication network 30 supports forming of a communication channel between the terminal apparatus 10 and the message service providing apparatus 20, a communication channel for support of a message service between the terminal apparatus 10 and another terminal apparatus, or the like. For example, the communication network 30 may form a communication channel for support of a short message service (SMS), a long message service (LMS) and a multimedia message service (MMS) for transmission of the message service of the present invention. Further, the communication network 30 may form a data service channel such as a social network service (SNS) channel, a chat service channel or an E-mail service channel for message service transmission of the present invention. Accordingly, the terminal apparatus 10 or another terminal apparatus may transmit a message having various terms, particularly, a specific term requiring comment information, to another terminal apparatus through at least one of data service channels, such as character-related service channels of SMS, LMS and MMS schemes, an SNS, a chat service and an email service using the communication network 30, and the other terminal may receive and output the message.

The terminal apparatus 10 is an apparatus of a user using a message service, and may connect to the communication network 30 and connect to the message service providing apparatus 20 connected to the communication network 30. Also, the terminal apparatus 10 may use the message service with another terminal apparatus based on the message service providing apparatus 20. For this, the terminal apparatus 10 may provide its own unique information or identification information to the message service providing apparatus 20, and the other terminal using the message service together with the terminal apparatus 10 may provide its own unique information or identification information to the message service providing apparatus 20. Also, the terminal apparatus 10 installs a specific application for use of the message service according to an operating policy of the message service providing apparatus 20 and supports message service operation based on the installed application.

Particularly, the terminal apparatus 10 may output a transmitted or received message, and may produce a message to request comment information on a specific term included in the message when receiving a request to provide the comment information for the specific term included in the message, and transmit the message to the message service providing apparatus 20. Also, when the terminal apparatus 10 receives the comment information for the specific term from the message service providing apparatus 20, the terminal apparatus 10 may output the comment information. In another embodiment, the terminal apparatus 10 receives the message through the message service providing apparatus 20, and may receive the comment information provided by the message service providing apparatus 20 together with the message and output the same.

Meanwhile, the terminal apparatus 10 may produce the message in which the comment information for the specific term has been recorded according to a user input and provide the message in which the comment information for the specific term has been recorded to the message service providing apparatus 20. In addition, the terminal apparatus 10 may build a comment information database in a storage unit in order to independently provide the comment information for the specific term. In this case, the terminal apparatus 10 may provide the comment information for the specific term designated in the received message based on the comment information database stored in the storage unit.

The message service providing apparatus 20 has a configuration for providing the comment information for the specific term requested by the terminal apparatus 10 while supporting the message service for the terminal apparatus 10. Here, the message service providing apparatus 20 may include both of a message service providing function of providing a message service and a comment information providing function of providing the comment information for the specific term, or may include only any one or both of the functions according to a manual mode or an automatic mode which will be described below.

The message service providing apparatus 20 supports channel formation and transmission and reception of a message in order to support the message service between the terminal apparatuses 10. The service channel provided by the message service providing apparatus may include at least one of the character-related message service channel and the data service channel described above.

A comment information providing apparatus in the message service providing apparatus 20 may support adaptive provision of the comment information for the specific term of the transmitted or received message according to various policies and design schemes. In other words, the message service providing apparatus 20 may support at least one of a passive comment information providing service for the specific term requested by the terminal apparatus 10, an automatic comment information providing service for the specific term of the transmitted or received message, and a comment information database updating service for independent comment information provision of the terminal apparatus 10 according to a setting of the terminal apparatus 10.

Further, the message service providing apparatus 20 may perform processes such as various searches, information collection and filtering in order to update the comment information database stored in its own storage unit. Particularly, in order to provide comment information for terms such as jargon, informal language, or slang, the message service providing apparatus 20 may perform collection of meanings in a dictionary, as well as collection of definition information for the terms, mapping between the collected pieces of information, and checking of reliability.

Further, the message service providing apparatus 20 may perform support to collect the terms, as well as neighboring terms in an environment in which the terms are used, and provide a literal meaning as well as a situational meaning. When the neighboring terms are collected, the message service providing apparatus 20 may collect, for example sentences, adjacent terms in the sentence using a specific term as well as a plurality of previous and subsequent sentences using the term, and perform management of the collected example sentences and extraction and management of terms in the example sentence.

Further, the message service providing apparatus 20 may collect definition information for terms, as well as personal information of users using the message service, specifically, personal information including one or more of age in which a difference in culture can be judged, sex, a specialized field or occupation, region, nationality, and hobby, and may predict a difference in culture between a message sender and a message recipient based on the collected personal information.

Hereinafter, a main configuration and an operating method of the terminal apparatus 10 according to an embodiment of the present invention will be described.

FIG. 2 is a block diagram illustrating a main configuration of the terminal apparatus according to an embodiment of the present invention illustrated in FIG. 1.

Referring to FIGS. 1 and 2, the terminal apparatus 10 according to an embodiment of the present invention may include a communication unit 11, a control unit 12, an input unit 13, a storage unit 14, a display unit 15 and a sound source output unit 16. The control unit 12 may further include an application execution unit 12a and a link information management unit 12b. Further, the storage unit 14 may include a file list database (DB) 14a, an attached file DB 14b, and a message program 14c. Further, the display unit 15 may further include a user interface 15a.

Each component will be described in greater detail. First, the communication unit 11 transmits or receives a message through the communication network 30. For example, the communication unit 11 may transmit a message input by a user to the message service providing apparatus 20, and receive a message from the message service providing apparatus 20.

Further, the communication unit 11 may transmit or receive a message to or from a plurality of partner terminal apparatuses and may be implemented to include various types of communication modules for transmission and reception of information.

The control unit 12 controls power supply to each component of the terminal apparatus 10 and a flow of signals for function execution, and may be a processing device which drives an operating system (OS) and each configuration, such as a central processing unit (CPU).

This control unit 12 of the present invention supports a message information protection function. In other words, the control unit 12 controls extraction of a part corresponding to confidential information and setting of the protection function for only the corresponding part when the confidential information is included in a message input by the user and a message received from the partner.

Then, the control unit 12 displays the message in which the protection function has been set through the display unit 15 which will be described below after applying the protection function to only the part corresponding to the confidential information.

The protection function refers to adjusting shade, color, brightness or screen brightness of the part corresponding to the confidential information according to a user setting so that the message cannot be confirmed. Further, sizes of characters corresponding to the extracted part may be adjusted.

In this case, a protection function applying criterion may be differently designated according to a user setting. For example, a range may be designated to apply the protection function as described above in any one of line units, phrase units, and syllable units.

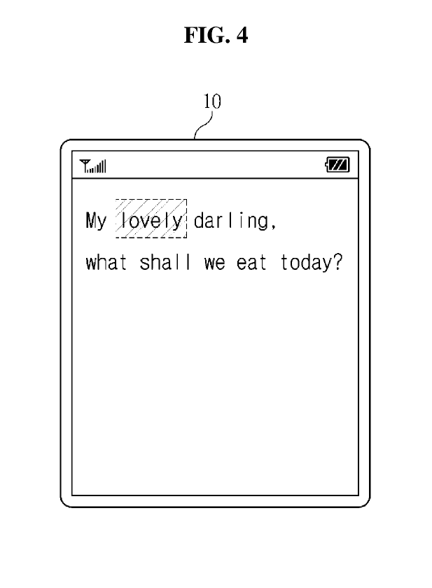

A description will be given with reference to FIGS. 3 to 5.

FIGS. 3 to 5 are illustrative diagrams illustrating the protection function applying criterion. The user terminal apparatus 10 in which a part corresponding to previously set confidential information (keyword “love”) is extracted from a message received from a partner, i.e., “My lovely darling, what shall we eat today,” and a protection function (shade) is applied to the extracted part is shown.

Particularly, a state in which the protection function applying criterion is set as a line unit is illustrated in FIG. 3. As illustrated in FIG. 3, when the protection function applying criterion is set to be applied in line units, the protection function is applied to an entire line (“My lovely darling”) including the keyword “love.”

If the protection function is set to be applied in phrase units, the protection function is applied to only the phrase (“lovely”) including the keyword “love,” as illustrated in FIG. 4.

Further, when the protection function is set to be applied in syllable units, the protection may be applied to only the part corresponding to “love,” as illustrated in FIG. 5.

Then, when a password is input by a user to confirm the message to which the protection function has been set and when the input password matches a previously set password, the control unit 12 may perform control to cancel the protection function so that the entire message is displayed.

Here, the password may be a password set by the user or a previously set password in the terminal apparatus 10 for using the message information protection function.

The input unit 13 receives various pieces of information such as number or character information, and transfers a signal input in connection with a setting of various functions and function control of the terminal apparatus 10 to the control unit 12. Particularly, the input unit 34 of the present invention supports input of the user for a message to be transmitted to the partner and supports input of a password for confirming a message in which the protection function has been set. In addition, the input unit 34 supports various user inputs for message information protection.

This input unit 13 may include at least one of a keypad and a touch pad which generate an input signal according to a touch and a manipulation of the user. In this case, the input unit 13 may be configured in the form of one touch panel (or a touch screen) together with the display unit 15 which will be described below, and perform both an input function and a display function. Further, the input unit 13 may include one or more of a key input means such as a keyboard or a keypad, a touch input means such as a touch sensor or a touch pad, a gesture input means including at least one of a gyroscope sensor, a geomagnetic sensor, an acceleration sensor and a proximity sensor, and the camera, and a voice inputting means. In addition, the input unit 13 may include any type of input means that has been developed or that may be developed in future.

The storage unit 14 stores an application necessary for functional operation according to an embodiment of the present invention, as well as various data generated during execution of the application. Particularly, the storage unit 14 of the present invention stores various pieces of information for transmission and reception of messages and stores a message input by the user and a message received from a partner terminal, e.g., the second terminal apparatus 10b.

The confidential information and the protection function setting criterion set by the user may also be stored.

Such a storage unit 14 may mainly include a program area and a data area. The program area stores related information for driving of the terminal apparatus 10, such as an OS which boots the terminal apparatus 10. The data area is an area in which data generated according to use of the terminal apparatus 10 is stored, and a message input by the user and a message received from the partner may be stored.

Such a storage unit 14 may include a storage medium, such as a flash memory, a hard disk, a multimedia card micro type memory (e.g., an SD or an XD memory), a RAM or a ROM.

The display unit 15 displays information such as a series of operating states and operation results generated during execution of functions of the terminal apparatus 10. For example, the display unit 15 displays various types of information which may be provided to the user, such as various menus for message input, a message input by the user, or a message received from the partner. Particularly, the display unit 15 according to an embodiment of the present invention can display the message to which the protection function has been applied.

Such a display unit 15 may include a liquid crystal display (LCD), a thin film transistor LCD (TFT-LCD), an organic light emitting diode (OLED), a light emitting diode (LED), an active matrix organic LED (AMOLED), a flexible display or a three-dimensional display.

The sound source output unit 16 converts a sound source that is an electrical signal into an analog signal and outputs the analog signal to the outside, and may output various pieces of information related to display of the message.

For example, when a password input by the user to release the set protection function is different from a previously set password, the sound source output unit 16 may perform a function of outputting an alarm sound source.

The main configuration and the operation method of the terminal apparatus 10 according to an embodiment of the present invention have been described above.

In an embodiment of the present invention, the example in which the terminal apparatus 10 determines whether the confidential information is included in the message input by the user or the message received from the partner, extracts a corresponding part when the confidential information is included, and sets the protection function has been described, but the message service providing apparatus 20 may determine whether the confidential information is included, extract the corresponding part when the confidential information is included, and then set the protection function for only the extracted part.

In this case, the terminal apparatus 10 may display a message in which the protection function has been set in response to a control command of the message service providing apparatus 20 and play only a role of supporting input of the password of the user.

Meanwhile, in the terminal apparatus 10 according to an embodiment of the present invention, the input unit 13 detects a touch signal or a keypad signal input to confirm the messenger service and an attached file received through the messenger service and transmits the signal to the control unit 12.

The display unit 15 displays an execution screen of the messenger service, a screen related to the attached file provided through the messenger service, or the like.

The program area of the storage unit 14 stores an operating system for booting the terminal apparatus 10, a program for executing the messenger service, a program for outputting the attached file provided through the messenger service, a program for generating link information for a specific file, or the like.

Further, the data area of the storage unit 14 is an area in which data generated according to the use of the terminal apparatus 10 is stored. Particularly, the data area according to an embodiment of the present invention stores conversation information generated according to execution of the messenger service, the attached file DB 14b received during a conversation, link information for the attached file received during the conversation, the file list DB 14a including the link information, or the like. Here, the attached file is information such as a document file, a music file, a video file, and URL information received from a specific terminal during use of the messenger service, and is stored in the attached file DB 14b. Further, the link information identifies each attached file, and includes information such as a file name, a file size, an extension and a file format of the attached file.

The sound source output unit 16 outputs all sound effects, setting sounds and execution sounds related to the execution of the functions of the terminal apparatus 10, the messenger service, and attached files provided through the messenger service.

The communication unit 11 includes an RF transmission means which up-converts a frequency of a transmitted signal and amplifies the signal, and an RF reception means which low-noise-amplifies a received signal and down-converts a frequency of the signal. The communication unit 11 may include at least one of a wireless communication module (not illustrated) and a wired communication module (not illustrated). Also, the wireless communication module has a configuration for transmitting or receiving data according to a wireless communication method, and when the terminal apparatus 10 uses wireless communication, the terminal apparatus 10 may transmit or receive data to or from the message service providing apparatus 20 using one of a wireless network communication module, a WLAN communication module and a WPAN communication module. Further, the wired communication module is intended to transmit or receive data in a wired manner. The wired communication module may access the communication network 30 through a cable and transmit or receive data to or from the terminal apparatus 10 and the message service providing apparatus 20. In other words, the terminal apparatus 10 may connect the communication network 30 using the wired communication module to transmit or receive data to or from the message service providing apparatus 20 through the communication network 30. Particularly, the communication unit 11 according to the present invention transmits an attached file provided through the messenger service among a plurality of terminal apparatuses and the messenger service using communication with the message service providing apparatus 20 to the terminal apparatuses participating in the messenger service or the message service providing apparatus 20.

The control unit 12 requests the message service providing apparatus 20 to provide the file list for the attached file received from the terminal of the partner during use of the messenger service. For example, the attached file includes information such as a document file, a music file, a video file, or URL information received from the partner during use of the messenger service.

The control unit 12 receives the file list from the message service providing apparatus 20, and selects the attached file in the received file list. Also, the control unit 12 requests the service apparatus to transmit the selected attached file, receives the attached file according to the request, and outputs the attached file.

Further, the control unit 12 receives the attached file from the terminal of the partner during use of the messenger service, and generates link information related to the received attached file. For example, the link information identifies each attached file, and includes information such as a file name, a file size, an extension and a file format of the attached file. Also, the control unit 12 stores and manages the generated link information as a file list.

When the messenger service is being used, the control unit 12 presents the file list in response to a request of the user and confirms the selected link information in the present file list. Also, the control unit 12 reads the attached file corresponding to the confirmed link information, and outputs the read attached file.

The control unit 12 includes an application execution unit 12a and a link information management unit 12b in order to effectively perform the function of such a terminal apparatus 10. Particularly, the application execution unit 12a executes a messenger service with other terminal apparatuses and manages the data transmitted or received through the messenger service. Further, the link information management unit 12b includes the attached file received from the partner in the file list during use of the messenger service, and manages the attached file. In this case, the link information management unit 12a generates the link information for the attached file and stores the generated link information in the file list.

Meanwhile, in the terminal apparatus 10 according to an embodiment of the present invention, the communication unit 11 transmits or receives a message between the terminal apparatus in which a communication channel is established through the communication network 30. For example, when a message is input by the user of the first terminal apparatus 10a, the communication unit 11 transmits the input message to a partner terminal with which the conversation channel has been established, e.g., one or more second terminal apparatuses 10b, and receives a message input by the users of the one or more second terminal apparatuses 10b.

Further, the communication unit 11 may transmit a request for analysis of the message transmitted or received through the conversation channel to the message service providing apparatus 20, and receive the statistic result for the message from the message service providing apparatus 20. This communication unit 11 of the present invention may include various types of communication modules for transmission and reception of the information.

When the request for analysis for the message transmitted or received from the user through the conversation channel is input, the control unit 12 transmits the analysis request to the message service providing apparatus 20, and receives a statistic result for the message analysis from the message service providing apparatus 20 to provide the statistic result to the user, or the control unit 12 of the terminal apparatus 10 may analyze the message transmitted or received through the conversation channel, output an analysis result and provide the analysis result to the user.

In this case, when the user inputs a message analysis request using a user interface 15a provided through the display unit 15 which will be described below and selects a previously set analysis item through the user interface 15a, the control unit 12 controls a series of processes of analyzing a message transmitted or received through the conversation channel to date based on the analysis item selected through the user interface 15a, and providing an analysis result to the user through the user interface 15a of the display unit 15.

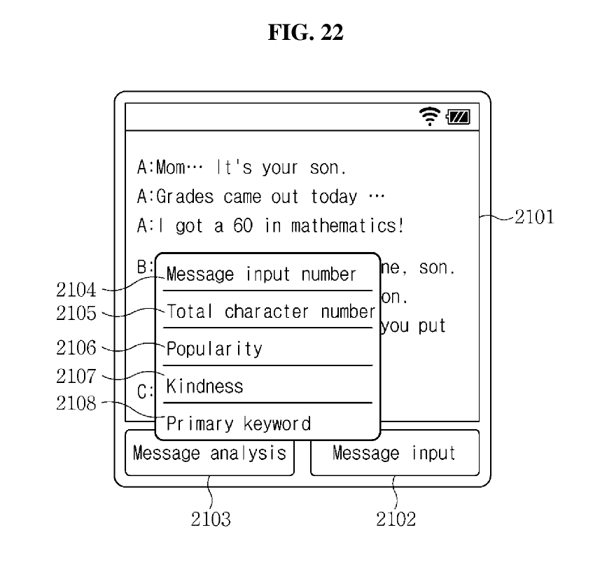

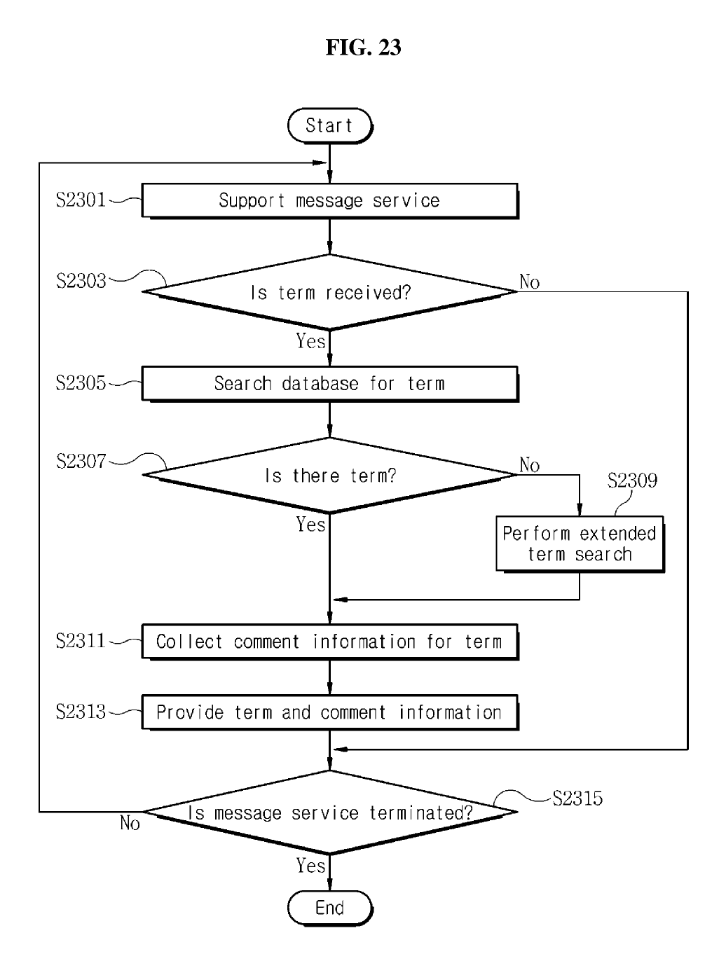

The user interface for message analysis will be described in greater detail with reference to FIGS. 22 and 23 and other components will be described.

The input unit 13 supports input of a message to be transmitted to the partner and input of the user for message analysis. In addition, the input unit 13 may support inputs of various users for message service providing.

The storage unit 14 may store various pieces of information for message transmission and reception and store the message input by the user and the message received from the partner. Further, when the control unit 12 of the terminal apparatus 10 directly provides a message service, the storage unit 14 may store various pieces of information for message service provision.

The program area of the storage unit 14 stores related information for driving the terminal apparatus 10, such as an OS which boots the terminal apparatus 10. The data area is an area in which data generated according to the use of the terminal apparatus 10 is stored, and the message input by the user and the message received from the partner may be stored.

The display unit 15 provides the user interface 15a for message analysis and provides various analysis items through the user interface 15a.

The sound source output unit 16 may output various pieces of information related to the display of the message.

Meanwhile, the terminal apparatus 10 according to an embodiment of the present invention may be designed in at least one of a message service providing apparatus 20 based comment information service operation using the message service providing apparatus 20 and a self comment information service operation using its own comment information database in a comment information service operation.

First, in the message service providing apparatus 20 based comment information service operation, comment information for a specific term included in the message is transferred to the message service providing apparatus 20, the comment information for the term is received from the message service providing apparatus 20, and the comment information is output. Further, in the message service providing apparatus 20 based comment information service operation, an automatic mode is requested to be set and a message including the comment information is received from the message service providing apparatus 20. Meanwhile, the self comment information service operation has a structure of searching for a specific term designated by a received message based on the comment information database stored in the storage unit 14, and providing the specific term. In addition, in response to the user request or when a term to be searched is a non-registered word in the self comment information service, the operation may be switched to the message service providing apparatus 20 based comment information service operation.

For this, the communication unit 11 forms a communication channel for supporting a communication function of the terminal apparatus 10. Particularly, the communication unit 11 may form the communication channel with the message service providing apparatus 20 through the communication network 30. Through the communication channel formed with the message service providing apparatus 20, the terminal apparatus 10 may receive a message and transmit a comment information search request message for the specific term or perform message transmission for setting an automatic mode to the message service providing apparatus 20. Also, the communication unit 11 may receive the comment information for the specific term from the message service providing apparatus 20 or receive a message in which the specific comment information has been recorded.

The input unit 13 may generate an input signal for confirmation of the received message and an input signal for designating a specific term in order to request the comment information for the specific term according to a user manipulation. Further, the input unit 13 may generate a connection request signal of the message service providing apparatus 20 and an input signal for setting the automatic mode in order to set the automatic mode.

The sound source output unit 16 can provide sound effects to inform of reception of the message. In this case, the sound source output unit 16 may provide the sound effects of the message including the comment information to be distinguished from reception of other messages. Meanwhile, the output of the sound effects described above may be omitted according to the selection of the user.

The display unit 15 may provide the message output screen provided by the message service providing apparatus 20. In this case, the message output screen output by the display unit 15 may automatically support marking for terms requiring comment information. In other words, the message output screen may be output so that specific terms in the content of the message are distinguished from other terms. For this, the control unit 12 may extract terms included in content of a message at the time of reception of the message and confirm whether the extracted terms are information included in the comment information database stored in the storage unit 14. The terms included in the comment information database may be output to be distinguished from other terms on the message output screen. Meanwhile, when a specific message is received, the display unit 15 may differently display a type of the received message, i.e., reception of a message including comment information and a message including no comment information. In other words, the display unit 15 may differently display an icon indicating reception of the message including comment information and an icon indicating reception of the message including no comment information. Meanwhile, the display unit 15 described above may be prepared in the form of a touch screen including a touch panel and used as an input means.

The storage unit 14 may store a message program 14c in order to support the message service and provide a comment information service. Also, the storage unit 14 may store a comment information database for providing a comment information service of the programs 14c. The message program 14c is a structure for supporting a message operation of the terminal apparatus 10, and performs various service supports such as SMS messaging, chat messaging, or email. Particularly, the message program 14c may support search of terms included in the specific message, and collection and output of comment information on the terms.

The control unit 12 may support a signal flow and data control for comment information provision of the present invention.

This will be described in greater detail. The control unit 12 may transmit a request for setting an automatic mode to the message service providing apparatus 20 according to a user request. Accordingly, when the terminal apparatus 10 receives the message including comment information, the control unit 12 supports output of this message to the display unit 15.

Meanwhile, when a message is received, the control unit 12 supports output of the received message and confirms whether specific term selection for providing the comment information occurs. In order to support this, the control unit 12 may confirm content of the message and perform support so that terms registered in the comment information database 251 are distinguished from other terms and output. Also, when a specific term is selected, the control unit 12 may extract the comment information of the term from the comment information database 251 and perform support so that the comment information is output to the display unit 15. The comment information may be output through a separate popup window or output to an area of the display unit adjacent to the term 15.

Meanwhile, when there is no specific term selected by the user in the comment information database 251, the control unit 12 may transmit the term to the message service providing apparatus 20 to request the comment information. In this process, the control unit 12 supports confirmation from a user for whether the comment information of the term is to be collected using the message service providing apparatus 20. Also, when the comment information is received from the message service providing apparatus 20, the control unit 12 may support output of this comment information as the comment information for the term.

In addition, the control unit 12 may perform connection of message service providing apparatus 20 in a certain period or in real time for updating of the comment information database stored in the storage unit 14. Also, when the control unit 12 receives the update information of the comment information database from the message service providing apparatus 20, the control unit 12 may control updating of the comment information database stored in the storage unit 14 using this update information. Further, the control unit 12 records the comment information for the specific term and provides the recorded comment information of the specific term to the message service providing apparatus 20 under the control of the user.

Hereinafter, a main configuration and an operation method of the message service providing apparatus 20 according to an embodiment of the present invention will be described.

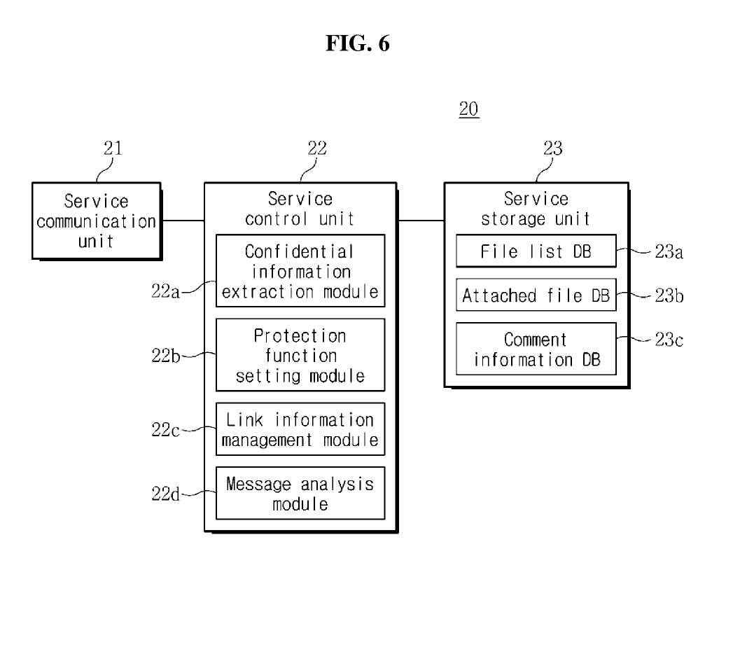

FIG. 6 is a block diagram illustrating a main configuration of the message service providing apparatus according to an embodiment of the present invention as illustrated in FIG. 1.

Referring to FIGS. 1 and 6, the message service providing apparatus 20 according to an embodiment of the present invention may include a service communication unit 21, a service control unit 22 and a service storage unit 23. The service control unit 22 may further include a confidential information extraction module 22a, a protection function setting module 22b, a link information management module 22c and/or a message analysis module 22d. Further, the service storage unit 23 may further include a file list DB 23a, an attached file DB 23b and/or a comment information DB 23c.

Hereinafter, each component will be described in greater detail. The service communication unit 21 transmits or receives related information to or from the terminal apparatus 10 through the communication network 30. For example, the service communication unit 21 may transmit a message received from the first terminal apparatus 10a to the second terminal apparatus 10b.

The service control unit 22 performs general control of the message service providing apparatus 20 of the present invention. Particularly, when a message is received from any one user terminal, e.g., the first terminal apparatus 10a, the service control unit 22 determines whether confidential information is included in the received message, extracts a corresponding part, sets a protection function for only the extracted part when the confidential information is included, and controls transmission of the message in which the protection function has been set to a partner terminal, e.g., the second terminal apparatus 10b.

This will be described in greater detail. The confidential information according to the user setting is first received from the user terminal, e.g., the first terminal apparatus 10a. In this case, the identification information of the first terminal apparatus 10a is received together, and the received confidential information is matched to correspond to the identification information and stored in the service storage unit 23 which will be described below.

Here, the confidential information is confidential information according to the user setting, and information such as an account number, an address, a phone number or a specific keyword such as “love” may be set as the confidential information.

Then, when a message is received from the first terminal apparatus 10a, the service control unit 22 confirms previously set confidential information to correspond to the identification information (e.g., a phone number) of the first terminal apparatus 10a included in the message.

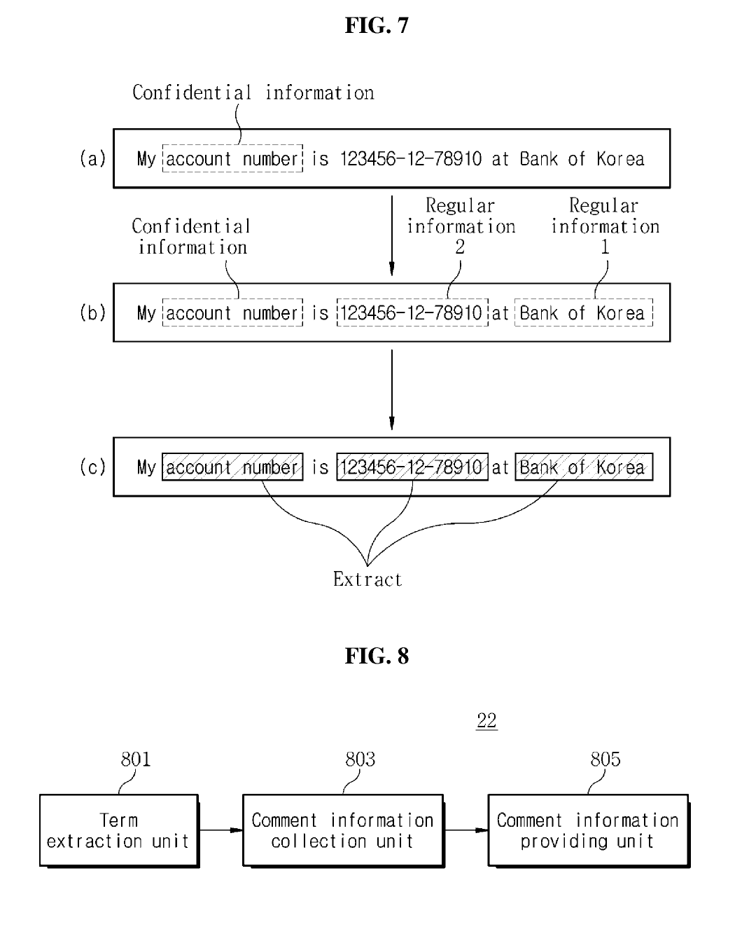

This will be described with reference to FIG. 7.

FIG. 7 is an illustrative diagram of a screen illustrating a method of extracting a part corresponding to confidential information. For example, a method of extracting a part corresponding to confidential information from a message (“My account is 123456-12-78910 at the Bank of Korea”) received from the first terminal apparatus 10a is illustrated.

As illustrated in FIG. 7, when the message (“My account is 123456-12-78910 of the Bank of Korea”) is received from the first terminal apparatus 10a, the service control unit 22 first extracts a keyword (account) corresponding to “account number” which is confidential information previously set by the first terminal apparatus 10a.

In an embodiment of the present invention, a situation in which the previously set confidential information is the account number will be described by way of example. In this case, the confidential information is set, for example, by the first terminal apparatus 10a, but the present invention is not limited thereto and the confidential information may be set by the service control unit 22.

Then, the service control unit 22 confirms regular information corresponding to the account number that is the previously set confidential information.

In other words, the account number is not merely a list of numbers, but includes information on a bank name, an account number, and an account holder. Here, the information on the bank name, account number, and account holder are regular information.

The service control unit 22 extracts the regular information corresponding to the confidential information from such a message together and, for example, first extracts a part corresponding to the regular information of the bank name, as illustrated in FIG. 7.

In the case of the bank name, since the number of existing banks is limited, previously set bank name information, i.e., “the Bank of Korea” is extracted. Then, an account number generation rule corresponding to the Bank of Korea is confirmed.

For example, when the account number generation rule of the Bank of Korea is 000000-00-00000, the service control unit 22 may perform control to detect only a number part corresponding to the account number generation rule from the message and not to detect other numbers.

Further, information for the account holder is not illustrated in the drawings, but when there are characters corresponding to the name, a corresponding part may be extracted and the protection function may be applied.

In another example, when the confidential information previously set by the first terminal apparatus 10a is a phone number and the message received from the first terminal apparatus 10a is “Kim Patent 123-1234-1234,” the service control unit 22 confirms the phone number that is the previously set confidential information and confirms the regular information corresponding to the phone number when receiving the message described above.

For example, the regular information corresponding to the phone number may be a name and a phone number. Here, the phone number may be a number of consecutive digits, i.e., “000 or 0000? 0000-0000.”

A message received according to this regular information is examined to extract the consecutive digits 123-1234-1234 satisfying the above rule and extract a name near the extracted number.

Here, the name may be in the form of family name-name, and the family name may be first detected, and two or three characters subsequent to the family name may be detected as a name.

When the part corresponding to the confidential information is extracted through such a process, the protection function is set for only the extracted part and the message is transmitted to the second terminal apparatus 10b which is the terminal apparatus of the partner.

In this case, when the service control unit 22 transmits only information for the protection function applying criterion set by the first terminal apparatus 10a to the second terminal apparatus 10b, the second terminal apparatus 10b may apply the protection function according to the received protection function applying criterion and perform display.

Thus, there is an advantage that efficiency of the message information protection method can be improved by applying the protection function in consideration of all of various rules in response to the confidential information according to the user setting.

For this, the service control unit 22 may include a confidential information extraction module 22a which extracts confidential information according to a set rule, and a protection function setting module 22b which sets a protection function according to the protection function applying criterion.

Further, the service storage unit 23 stores general information for setting the protection function for a message transmitted or received between the terminal apparatuses 10, and the service storage unit 23 according to an embodiment of the present invention may store the confidential information and the corresponding regular information set by the user, and may store various pieces of information for setting the protection function.

Meanwhile, in the message service providing apparatus 20 according to an embodiment of the present invention, the service communication unit 23 provides a file list to the terminal apparatus 10 based on control of the service control unit 21 and transmits an attached file corresponding to specific link information selected from among the file list to the corresponding terminal.

The service storage unit 22 stores a series of data for providing the messenger service, and stores an attached file, link information related to the attached file, and a file list including the link information transmitted or received during use of the messenger service. For this, the service storage unit 22 stores an attached file DB 22b in which the attached file is stored, and a file list DB 22a for managing the link information related to the attached file.

The service control unit 21 provides a messenger service among a plurality of terminal apparatuses. Also, the service control unit 21 confirms an attached file transmitted from a specific terminal using the messenger service. Here, the attached file includes a document file, a music file, a video file, URL information or the like received from the terminal of the partner during use of the messenger service.

The service control unit 21 generates the link information related to the attached file and stores the generated link information in the file list. In this case, the service control unit 21 compresses the received attached file, classifies the attached file in conversation units or conversation partner units for the messenger service, and stores the compressed attached file and the link information to be matched according to the classification unit. For example, the link information identifies each attached file and includes information such as a file name, a file size, an extension and a file format of the attached file.

The service control unit 21 transmits the file list in response to the request of the terminal apparatus which uses the messenger service. Then, the service control unit 21 confirms the link information for the attached file selected from the file list, searches for the attached file corresponding to the confirmed link information, and transmits the attached file to the corresponding terminal.

The service control unit 21 includes a link information management module 21c in order to effectively perform the function of such a message service providing apparatus 20. Particularly, the link information management module 21c confirms the attached file transmitted or received through the messenger service executed among a plurality of terminal apparatuses, generates the link information related to the confirmed attached file, and then stores and manages the generated link information in the file list.

Further, the message service providing apparatus 20 configured as described above may be implemented by one or more servers operating in a server-based computing-based scheme or a cloud scheme. Particularly, the messenger service may be provided using a cloud computing device, and data for the attached file transmitted or received through the messenger service may be provided through a cloud computing function of performing permanent storage in a cloud computing device on the Internet. Here, the cloud computing refers to technology of servicing virtualized information technology (IT) resources, e.g., hardware (a server, a storage, a network or the like), software (a database, security, a web server or the like), service, data or the like in an on demand scheme utilizing Internet technology in a digital terminal such as a desktop PC, a tablet computer, a notebook PC, a netbook or a smartphone.

Meanwhile, a memory mounted on the message service providing apparatus 20 or the terminal apparatus 10 stores information in the device. In the case of one implementation, the memory is a computer-readable medium. In another implementation, the memory may be a volatile memory unit, and in another implementation, the memory may be a nonvolatile memory unit. In another implementation, the storage device is a computer-readable medium. In various other implementations, the storage device may include, for example, a hard disk device, an optical disc device or any other large-capacity storage device.

Meanwhile, in the message service providing apparatus 20 according to an embodiment of the present invention, the service communication unit 21 monitors and receives a message transmitted or received through at least one more conversation channel. For example, the service communication unit 21 receives a message transmitted or received between the first terminal apparatus 10a and one or more second terminal apparatuses 10b connected through the conversation channels.

Further, a message request for analysis for the message transmitted or received through the conversation channel to date may be received from any one terminal, e.g., the first terminal apparatus 10a among the first terminal apparatus 10a and one or more second terminal apparatuses 10b connected to the conversation channel, and a statistic result of the message may be transmitted to the terminal transmitting the request for analysis for the message, e.g., the first terminal apparatus 10a.

When the request for analysis for the message transmitted or received through the conversation channel is received from any one terminal participating in the conversation channel, e.g., the first terminal apparatus 10a, the service control unit 22 analyzes the message according to the previously set analysis item to calculate statistics and transmits a calculated statistic result to a terminal requesting the message analysis, e.g., the first terminal apparatus 10a.

More concretely, the present invention is intended enable easier recognition of content of the conversation by analyzing content of the message transmitted or received among a plurality of users. For this, the service control unit 22 analyzes the message transmitted or received through the conversation channel to date based on any one analysis item among the number of times a message is input for each terminal, a total number of characters, popularity, kindness, and a primary keyword to calculate statistics, and controls transmission of a calculated statistic result to the terminal requesting the message analysis.

For example, a state in which the first terminal apparatus, one or more second terminal apparatuses, and a third terminal apparatus transmit or receive a message through a specific conversation channel is assumed.

If a plurality of messages transmitted or received to date is 10, the first terminal apparatus has input 5 messages, the second terminal apparatus has input 3 messages, and the third terminal apparatus inputs 2 messages, the service control unit 22 counts the message input number for each terminal and transmits a statistic result, for example, a statistic result for the terminal apparatus (the first terminal) which has input the most messages and the terminal apparatus (the third terminal) which has input the least messages to the terminal requesting the message analysis.

Here, preferably, user information corresponding to the terminal, e.g., information such as a nickname or a name of the user, may be provided.

Further, a total number of characters of the messages input by the first terminal apparatus, the second terminal apparatus and the third terminal apparatus may be counted, and a statistical result, for example, information on the terminal having input the most messages and the terminal having input the least messages may be transmitted to the terminal requesting the message analysis.

Further, the popularity, the kindness or the like of the terminal participating in the conversation channel may be evaluated. Here, the popularity refers to an index indicating how many positive expressions are included in the response message of the partner based on the message input by the user, and the kindness refers to an index indicating how many positive expressions are included in the response message of the user in response to the message input by the partner.

Here, the response message may be a message of another user input within a certain period of time from a last message input by any one user. For example, if the second terminal apparatus and the third terminal apparatus have input messages within a certain period of time, for example, 3 seconds, in response to the message input by the first terminal apparatus, the message input within 3 seconds may be the response message.

The service control unit 22 counts the number of positive expressions in this response message, i.e., previously set positive words, and determines the popularity and the kindness based on this.

For example, the response message input by the second terminal apparatus is “good!” and the response message input by the third terminal apparatus is “bad!” in response to the message input by the first terminal apparatus.

Further, when the previously set positive word is “good,” since one positive word is included in the message input by the second terminal apparatus in response to the message input by the first terminal apparatus and no positive word is included in the message input by the third terminal apparatus in response to the message input by the first terminal apparatus, a total number of positive words in the response message of the partner in response to the message input by the first terminal apparatus is 1.

Accordingly, the popularity of the first terminal apparatus may be 1.

Similarly, a determination is made as to whether there is a previously set positive word in the response message of the first and third terminal apparatuses in response to the message input by the second terminal apparatus. When the first terminal apparatus has input three positive words and the third terminal apparatus has input one positive word, the popularity of the second terminal apparatus may be 4.

Thus, the popularity is calculated according to the number of included positive words, and a resultant statistic result, for example, a statistic result of a most popular user and a least popular user, is calculated and transmitted to the user terminal requesting the message analysis.

Similarly, since the kindness is an index indicating how many users input positive expressions based on the message input by the partner, positive words included in the response message input by the third terminal apparatus in response to messages input by the partners, for example, the messages input by the first terminal apparatus and the second terminal apparatus, may be counted to calculate the kindness, similar to the popularity, and the kindness may be provided to the user terminal apparatus the message analysis as described above.

Further, the service control unit 22 may analyze information such as primary keywords most used in the message transmitted or received through the conversation channel to date. In other words, the service control unit 22 parses the message transmitted or received through the conversation channel to date to extract words, and counts the extracted words to extract the primary keyword mentioned most frequently.

Thus, there is an advantage that the user participating in the conversation can more easily recognize the atmosphere of a current conversation channel, a user leading the conversation channel, and content of the main conversation by analyzing the message transmitted or received through the communication channel to date from various points of view and providing an analysis result to the user through the service control unit 22 of the present invention.

Further, there is an advantage that a late participant in the conversation channel can also recognize a situation of the current conversation channel more easily by requesting the message service providing apparatus 20 to analyze the message and then receiving a message analysis result.

For this, the service control unit 22 may further include a message analysis module 22d which analyzes a message according to a previously set analysis item.

Further, the service storage unit 23 permanently or temporarily stores the message transmitted or received through the conversation channel, and may store various pieces of information for message analysis, such as the analysis result of the service control unit 22 or the analysis items.

As described above, in an embodiment of the present invention, the example in which any one terminal among terminals participating in the conversation channel in a state in which the conversation channel is established with at least one partner terminal apparatus requests the message service providing apparatus 20 to analyze the message and receives the statistic result has been described, but the present invention is not limited thereto and the terminal apparatus 10 may directly analyze the message transmitted or received through the conversation channel and provide an analysis result to the user.

Meanwhile, the message service providing apparatus 20 according to an embodiment of the present invention forms the communication channel with the plurality of terminal apparatuses 10 based on the service communication unit 21 and supports operation of the message service channel in response to the request of the plurality of terminal apparatuses 10. In this process, when the specific terminal apparatus 10 makes a request to provide comment information for the term included in the specific message, the message service providing apparatus 20 collects the comment information in response to the request. Also, the message service providing apparatus 20 may transfer the collected comment information to the terminal apparatus 10. Meanwhile, the message service providing apparatus 20 may extract the terms of the specific message transmitted or received between the terminal apparatuses 10 according to a service policy or according to the request of the terminal apparatus 10, and support inclusion of the comment information for the term requiring the comment information. As described above, the message service providing apparatus 20 of the present invention can assist the user in understanding terms that the user finds difficult to understand by providing the comment information for the specific term included in the message.

For this, the service communication unit 21 supports the communication function of the message service providing apparatus 20. In other words, the service communication unit 21 may form the communication channel with the specific terminal apparatus 10 and support transfer of the message transferred by the terminal apparatus 10 to another terminal apparatus. In this case, the service communication unit 21 may receive a request for comment information for the specific term included in the message from the other terminal apparatus. Then, the service communication unit 21 may support transmission of the comment information according to the request of the comment information to the terminal under the control of the service control unit 22. This service communication unit 21 may include a communication module which can form the communication channel with the terminal apparatus 10. For example, when the terminal apparatus 10 is a mobile communication terminal, the service communication unit 21 may include a communication apparatus supporting the mobile communication.

Meanwhile, when the comment information providing scheme is set as an automatic mode, the service communication unit 21 may support transmission of the message including the comment information for the specific term included in the message to another terminal apparatus on the reception side. Here, the automatic mode may be a mode in which presence of a previously defined term among terms in the message transmitted according to a setting of a terminal on a transmission side or a reception side is automatically checked, the comment information for the term is included in the message when there is a specific term, and the resultant message is transmitted.

The service communication unit 21 may support extended comment information search and updating of the comment information DB 23c stored in the service storage unit 23. In other words, when the extended comment information search is performed according to the control of the service control unit 22, the service communication unit 21 may connect another service apparatus to search for comment information related to the term. For example, the service communication unit 21 may form the communication channel with a specific service apparatus newly defining a term or a service apparatus storing information in which a term requiring comment information search is used. Also, the service communication unit 21 may receive the comment information for the specific term from the service apparatus. Accordingly, the comment information may include various pieces of information such as a paragraph, a question and answer, and a sentence in which the specific term is used, as well as a description sentence explaining the specific term. The service communication unit 21 may include a separate communication module for connection of a specific service apparatus.

The service storage unit 23 has a configuration which stores various programs necessary for operation of the message service providing apparatus 20 of the present invention. In particular, the service storage unit 23 may include an operating system for a message service operation and a comment information DB 23c for comment information provision of the present invention.

Also, the service storage unit 23 may include a basic search module for searching for the comment information for the specific term included in the comment information DB 23c, and an extended search module for searching for the comment information for the specific term in other service apparatuses. Further, the service storage unit 23 may include an updating module for updating the comment information DB 23c.

The basic search module may be a module which performs search of a specific term in the comment information DB 23c stored in the service storage unit 23. Also, the extended search module may be a module which performs search of comment information of a term based on other service apparatuses or among information collected in other service apparatuses. The updating module has a configuration which performs updating of the information of the comment information DB 23c, and may support storing of terms and comment information provided by the specific terminal apparatus 10 in the comment information DB 23c. Further, the updating module may support updating of the comment information searched through the extended search in the comment information DB 23c.

The comment information DB 23c may include at least one term and at least one piece of comment information mapped with the term. Particularly, a plurality of pieces of comment information may be mapped with a specific term. In this case, a plurality of pieces of comment information may be arranged with certain reliability. The reliability information may be defined in a process in which first comment information is mapped with the corresponding term, and may be adjusted based on evaluation information for the comment information provided from the terminal apparatuses 10.

Meanwhile, the comment information stored in the comment information DB 23c may be classified and stored according to certain categories. Accordingly, different comment information may be provided according to the categories even for the same term. The categories may include, for example, at least one of various items such as life, society, economy, humor, games, sports, stocks, jargon, informal language and slang. A new category may be created by the addition of terms.

For example, the term “democratization” may be arranged in the society and jargon categories. “Democratization” assigned to the society category may mean a state of democracy being established according to activity for democratic establishment while “democratization” assigned to the jargon category may mean negligence or violence. For support of the comment information for the terms, terms mapped to the comment information of the comment information DB 23c may include a plurality of words or sentences, as well as words. For example, terms having a plurality of words such as “democratization” and “became” are classified into the social category and the corresponding comment information can be searched, and terms having a plurality of words such as “democratization” and “subjected” are classified into the jargon category and the corresponding comment information may be searched.

As described above, the terms may be classified into different categories, and accordingly, the terms stored in the comment information DB 23c for accurate comment information providing may include one word or term, as well as other words or terms in a sentence in which the specific word is used. For distinction of categories of terms, information for a sentence in which terms are applied and other words in the sentence may be stored together, in addition to the specific term.

Further, the comment information stored in the comment information DB 23c may be classified according to an age range, educational background, sex, nationality, field of study or the like for a used term. For example, for the specific terms and the comment information stored in the comment information DB 23c, terms mainly used in each age range, terms mainly used in each educational background, and terms mainly used by each sex are classified and stored in the storing process.

Therefore, in the comment information DB 23c of the present invention, even when terms are the same, content of the comment information may be different in the age range of the user of the terminal apparatus 10, and the content of the comment information explaining the term may be differently supported according to a specific distinction such as sex or educational background.

Further, even when meanings of the terms used for the comment information are the same, words of the comment information explaining the terms may be different. For example, for the information of the comment of the terms for each age range, a description for teens, a description for 20s, a description for 30s, and a description for 60s may be provided using different words and sentence structures. The comment information may be provided as the comment information is classified based on an age range, sex and educational background of an information provider in a process of collecting information for terms initially. Further, an explanation or a definition corresponding to the age zone or the educational background for the specific term may be further included as comment information in the process of updating the comment information for the specific term in order to provide the comment information according to the distinction described above.

Here, a criterion database for specific words for each distinction can be provided for support of the comment information for each distinction. The criterion database may be information defining a criterion for the age zone or the educational background to which words used to explain the specific term correspond. The service control unit 22 may collect the comment information for the specific term based on the criterion database in a process of generating the comment information DB 23c or a process of updating the comment information DB 23c, and classify the comment information.

In addition, the service storage unit 23 may include unique information of the terminal apparatuses 10, e.g., phone numbers of the terminal apparatuses 10 or specific ID information assigned to the terminal apparatuses 10 in order to support the message service of the terminal apparatuses 10. Further, the service storage unit 23 may include user attribute information of each terminal apparatus 10, e.g., various pieces of personal information such as ages of users, sexes of the users, and educational backgrounds of the users under agreement of the terminal apparatus 10.

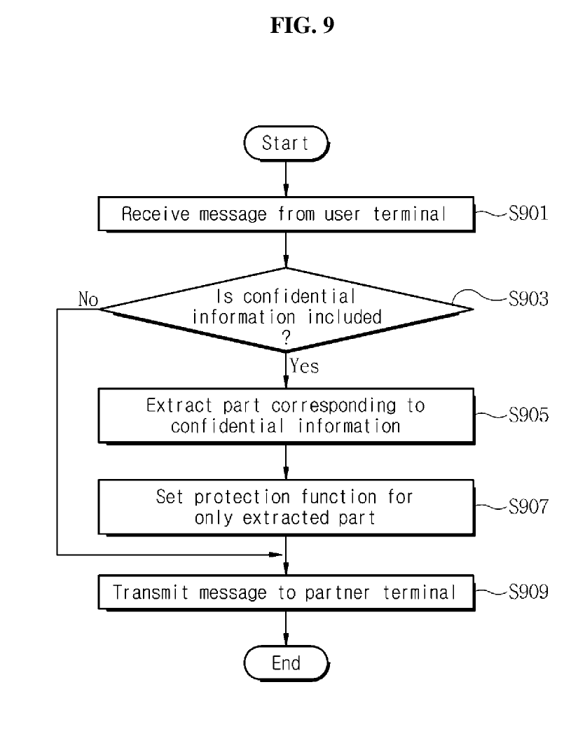

The service control unit 22 has a configuration which supports a general operation of the message service providing apparatus 20 for providing the comment information of the present invention and supports message transmission and reception between the terminal apparatuses 10 according to a design scheme. Particularly, the service control unit 22 may perform search of the comment information of the term requested by the specific terminal apparatus 10 in the manual mode, and provide the searched comment information to the terminal apparatus 10. Further, the service control unit 22 may automatically extract a term from the message transmitted to the specific terminal apparatus 10, and search for comment information for a specific term, include the comment information in the message, and provide comment information in the automatic mode. For this, the service control unit 22 may include a configuration shown in FIG. 8.

FIG. 8 is a diagram illustrating a configuration of the service control unit 22 in greater detail in a configuration of the message service providing apparatus 20 of the present invention.

Referring to FIG. 8, the service control unit 22 may include a term extraction unit 801, a comment information collection unit 803 and a comment information providing unit 805.

The term extraction unit 801 has a configuration for extracting content of at least a part for which comment information is to be provided from a received message. Particularly, the term extraction unit 801 extracts a term corresponding to specific content designated by a comment information request message transmitted by the specific terminal apparatus 10 in a manual mode. In this case, the term extraction unit 801 may transfer a term for which the comment information is to be searched in the comment information request message, as well as other terms in a sentence in which the term is described, to the comment information collection unit 803. Also, the term extraction unit 801 may transfer the extracted term to the comment information collection unit 803.

Further, the term extraction unit 801 may automatically extract specific terms from the message transmitted to the specific terminal apparatus 10 in an automatic mode, select certain terms according to a previously defined criterion from among the extracted terms, and transfer the selected terms to the comment information collection unit 803. This will be described in greater detail. The term extraction unit 801 separates the message into a plurality of morphemes, and extracts specific terms which can provide the comment information from the plurality of morphemes constituting the message. In other words, the term extraction unit 801 may confirm whether there are terms registered in the comment information DB 23c among the terms included in the message using the comment information DB 23c stored in the service storage unit 23. Also, when there are terms registered in the comment information DB 23c, the term extraction unit 801 may transfer the terms to the comment information collection unit 803.

The term extraction unit 801 may store information for the terminal apparatuses 10 in which the automatic mode has been set for support of the automatic mode. For this, the term extraction unit 801 may provide a message to the terminal apparatuses 10 to ask whether the automatic mode or the manual mode has been set at the time of the comment information service request of the specific terminal apparatus 10, and manage the terminal apparatuses 10 which support the automatic mode through a response thereto.

When the comment information collection unit 803 receives the specific terms from the term extraction unit 801, the comment information collection unit 803 collects the comment information for the received terms. Also, the comment information collection unit 803 may transfer the collected comment information to the comment information providing unit 805. For this, the comment information collection unit 803 confirms whether the terms transferred by the term extraction unit 801 are present in the comment information DB 23c. Also, when the corresponding terms are present in the comment information DB 23c, the comment information collection unit 803 may collect the corresponding comment information. In this process, the comment information collection unit 803 may classify the terms according to a category classification and collect the comment information corresponding to the category. For example, the comment information collection unit 803 may classify the terms into categories including one or more of life, society, economy, humor, games, sports, stocks, jargon, informal language, and slang, and may collect the comment information from the classified category. In this case, terms around the corresponding term may be further referenced upon classification of the category. Further, the comment information collection unit 803 may confirm a difference in culture based on personal information between a message sender and a message recipient and collect the comment information based on the culture difference. Specifically, the comment information collection unit 803 further confirms the personal information of the message sender and the message recipient, compares the personal information, and confirms the difference in culture between the message sender and the message recipient. Also, the comment information collection unit 803 may collect the comment information based on the difference in culture. For example, if the message sender is a man in his teens and the message recipient is a woman in her 30s, there may be a generational difference between the message sender and the message recipient, and in this case, the comment information collection unit 803 collects the comment information of items having a difference in culture, i.e., terms classified according to age. On the other hand, if the message sender is a woman in her 30s and the recipient is a woman in her teens, there is also a generational difference, but the comment information collection unit 803 may collect the comment information of the corresponding term in the category of an age group of 30s since the age of the message sender producing the message is 30s. On the other hand, if the message sender is an American man in his teens and the message recipient is a Korean man in his teens, there may be a difference in culture due to a difference in nationality, and in this case, the comment information collection unit 803 may collect the comment information from the category according to the nationality.

Meanwhile, the comment information collection unit 803 may perform extended search when the requested term is not registered in the comment information DB 23c. For this, the comment information collection unit 803 may activate the service communication unit 21 to connect another service apparatus connection, and perform comment information search based on the received term to collect at least one piece of search information on the term. Here, the comment information collection unit 803 may collect reliability information for the collected search information from the service apparatus and use the reliability information as reliability information of initial comment information. The comment information collection unit 803 may search for a term to be searched at the time of extended term search, as well as other terms extracted together from a sentence in which the term is described. Also, the comment information collection unit 803 may collect not only information such as a description or a definition of terms, but also information on a sentence or a question and answer in which the term is used at the time of information collection.

Meanwhile, the comment information collected by the comment information collection unit 803 may be used to update the comment information DB 23c. In this process, the comment information collection unit 803 may assign a certain category to the collected comment information, and may assign a distinction value indicating the difference in culture according to the age group, the sex or the educational background using the criterion database. The comment information collection unit 803 may transfer the collected comment information to the comment information providing unit 805.

The comment information providing unit 805 has a configuration of providing the comment information provided by the comment information collection unit 803 to the corresponding terminal apparatus 10. For this, the comment information providing unit 805 may store and manage the information of the terminal apparatus 10 requesting initial comment information search, and transfer the comment information for the term to the stored and managed terminal apparatus 10 when the comment information for the term is collected. In this case, the comment information providing unit 805 may transfer a message including the corresponding term and the comment information as a replay to the comment information request message from the terminal apparatus 10 in the manual mode. Also, the comment information providing unit 805 may record the comment information of the corresponding term in the message to be transmitted to the specific terminal apparatus 10 in the automatic mode, and control transmission of the message in which the comment information has been recorded. For this, the comment information providing unit 805 may refer to the information for the terminal apparatus 10 supporting the automatic mode managed by the term extraction unit 801. In other words, when the comment information providing unit 805 provides the comment information for the term, the comment information providing unit 805 may provide the comment information together with the term when the terminal apparatus 10 is set to the manual mode, and provide the comment information included in the message when the terminal apparatus 10 is set to the automatic mode.

Meanwhile, the configuration of the service control unit 22 described above may be designed as a control unit of the terminal apparatus 10 when the terminal apparatus 10 substantially supports the comment information providing service independently.

The message service providing apparatus 20 according to an embodiment of the present invention has been described above.

In an embodiment of the present invention, the example in which the message service providing apparatus 20 extracts the confidential information, sets the protection function, and transmits the resultant message to the partner terminal apparatus according to the confidential information set by the user terminal apparatus desiring to transmit the message to the partner terminal apparatus has been described, but the present invention is not limited thereto and the message service providing apparatus 20 may extract the confidential information, set the protection function and transmit the resultant message to the partner terminal apparatus according to confidential information set by the partner terminal apparatus which is to receive the message.

Further, the message service providing apparatus 20 described above may be implemented by one or more servers operating in a server-based computing-based scheme or a cloud scheme. Particularly, the information transmitted or received through the message service providing system 100 may be provided through a cloud computing function of performing permanent storage in a cloud computing device on the Internet. Here, the cloud computing refers to technology of servicing virtualized information technology (IT) resources, e.g., hardware (a server, a storage, a network or the like), software (database, security, web server or the like), service, data or the like in an on demand scheme by utilizing Internet technology in a digital terminal such as a desktop PC, a tablet computer, a notebook PC, a netbook or a smartphone. In the present invention, all pieces of information transmitted or received between the terminal apparatus 10 and the message service providing apparatus 20 may be stored in the cloud computing device on the Internet and transmitted anywhere at any time.

The main components of the terminal apparatus 10 and the message service providing apparatus 20 have been described above with reference to FIGS. 2 to 8. However, not all of the components described with reference to FIGS. 2 to 8 are essential components, and each apparatus may be implemented by more or fewer components than the components shown.

Hereinafter, a method of protecting message information according to an embodiment of the present invention will be described.

FIG. 9 is a flowchart illustrating a message service providing method according to an embodiment of the present invention.

Referring to FIGS. 1 and 9, when the message service providing apparatus 20 receives a message from a user terminal, e.g., the first terminal apparatus 10a (S901), the message service providing apparatus 20 first determines whether confidential information is included in the received message (S903).

When the confidential information is included in the received message as a result of the determination, the message service providing apparatus 20 extracts a part corresponding to the confidential information (S905), sets a protection function for only the extracted part (S907), and then transmits the message to a partner terminal, e.g., the second terminal apparatus 10b which will receive the message (S909).

Here, in step S905 of extracting the part corresponding to the confidential information, if the confidential information set by the user is irregular keyword information such as “love,” only the part corresponding to “love” is extracted from the received message, and if the confidential information is regular information such as an account number, a phone number or address information, the part is extracted in consideration of all pieces of regular information corresponding to the confidential information, as described with reference to FIGS. 4 and 5.

For example, if the confidential information is the account number, the part is extracted in consideration of all previously set regular information, a bank, an account number, and an account holder corresponding to the account number. Further, in the case of banks, since the number of existing banks is limited, information on the banks is first extracted based on previously stored bank information.

Then, when the extracted bank information is the Bank of Korea, a format of account numbers used by the Bank of Korea is confirmed. In other words, since indication formats of account numbers are different between banks, a number part corresponding to the account number is extracted according to the format of the account numbers used by the Bank of Korea.

In the case of the account holder, according to previously set regular information corresponding to the name, for example, a family name is first extracted, a character string in a certain range (2 to 3 characters) is determined to be a name, and the character string is extracted.

Through such a process, parts corresponding to the bank, the account number, and the account holder corresponding to the account number are all extracted, and then a protection function is set for only the extracted part.

It is preferable for the message service providing apparatus 20 to transmit only information on the protection function applying criterion according to the user setting to the partner terminal apparatus in response to the extracted part in step S907.

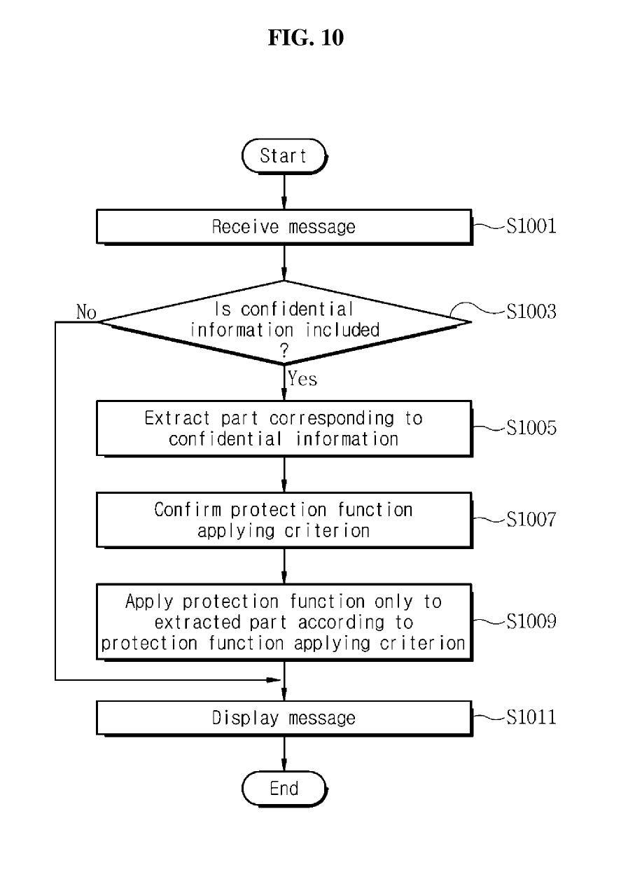

The protection function applying criterion will be described in greater detail with reference to FIG. 10.

FIG. 10 is a flowchart illustrating a message service providing method according to another embodiment of the present invention.

Referring to FIGS. 1 and 10, when a user terminal, e.g., the first terminal apparatus 10a, receives a message from any one of the message service providing apparatus 20 and the partner terminal, e.g., the second terminal apparatus 10b (S1001), the user terminal determines whether confidential information is included in the received message (S1003).

The user terminal then extracts a part corresponding to the confidential information (S1005). Since a process of extracting the part corresponding to the confidential information has been described with reference to FIG. 9, a concrete description is omitted.

A previously set protection function applying criterion is then confirmed (S1007).

The protection function applying criterion refers to information indicating a protection function to be applied based on any one of line units, phrase units, and syllable units.

For example, when the confidential information is set as a keyword “love,” a character string corresponding to the keyword “love” is extracted and then the protection function applying criterion is confirmed. When the protection function is set to be applied in line units, the protection function (adjustment of shade, color, brightness or screen brightness or adjustment of size) corresponding to all lines including the keyword “love” is applied.

When the protection function is set to be applied in the phrase unit, the protection function may be applied to only the phrase including the keyword “love.”

Further, when the protection function is set to be applied in the syllable unit, the protection function may be applied to only the syllable.

Then, the protection function is applied only to the extracted part according to the protection function applying criterion (S1009) and the message to which the protection function is applied is displayed (S1011).

According to such a message information protection method of the present invention, the present invention has an advantage in that, when the confidential information is included in the message received from the partner, selective message protection can be realized by setting the protection function for only the part corresponding to the confidential information.

Further, there is an advantage that efficiency of the message information protection method can be improved by applying the protection function in consideration of various rules in response to the confidential information according to the user setting.

Further, there is the advantage that the user can organically set an exposure level of information related to privacy by differently setting the protection function according to the user setting.

Next, a method of managing an attached file according to an embodiment of the present invention will be described.

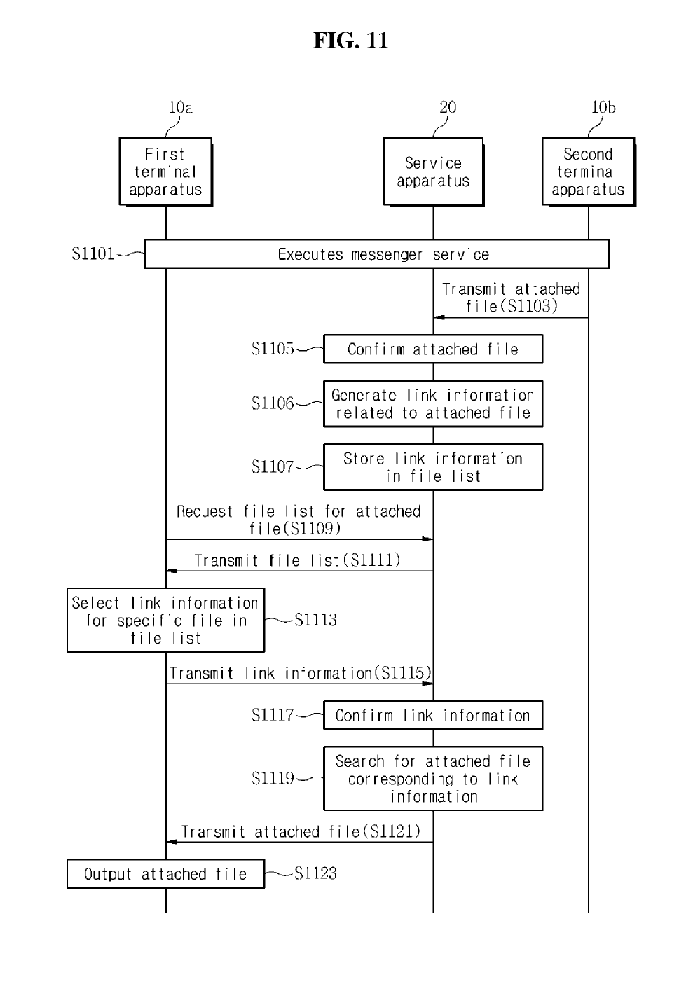

FIG. 11 is a data flow diagram illustrating a method of managing an attached file in a messenger service according to an embodiment of the present invention.

The method of managing an attached file in a messenger service according to the present invention will be described with reference to FIG. 11. The first terminal apparatus 10a executes a messenger service with the second terminal apparatus 10b through the message service providing apparatus 20 in step S11. Here, the first terminal apparatus 10a and the second terminal apparatus 10b are distinguished by terminology only for convenience of the description, and configurations and operations thereof may be the same. In other words, according to an embodiment of the present invention, the first terminal apparatus 10a may request the message service providing apparatus 20 to transmit a previously received attached file in order to confirm the attached file received from the second terminal apparatus 10b during use of the messenger service. Meanwhile, as such an operation, the second terminal 10b may request the message service providing apparatus 20 to transmit the previously received attached file in order to confirm the attached file received from the first terminal apparatus 10a during use of the messenger service.

During the execution of the messenger service, the second terminal apparatus 10b transmits the attached file to the message service providing apparatus 20 in step S1103. In response to the attached file transmission request, the message service providing apparatus 20 confirms the attached file received from the second terminal apparatus 10b in step S1105. Here, the attached file includes a document file, a music file, a video file, or URL information received from the partner terminal apparatus during the use of the messenger service.

The message service providing apparatus 20 generates link information related to the attached file in step S1106. In other words, the message service providing apparatus 20 confirms information such as a file name, a file size, an extension and a file format of the attached file to identify the received attached file. The message service providing apparatus 20 then stores the link information in a file list in step S1107. In this case, the message service providing apparatus 20 compresses the received attached file, classifies the attached file in conversation units or conversation partner units for the messenger service, and then stores the compressed attached file and the link information to be matched according to the classification unit.

The first terminal apparatus 10a requests the message service providing apparatus 20 to provide the file list for the received attached file during use of the messenger service in step S1109. In response to the file list request, the message service providing apparatus 20 transmits the previously set file list to the first terminal apparatus 10a in step S1111.

When the file list is received, the first terminal apparatus 10a selects the link information for a specific file included in the file list in step S1113. Also, the first terminal apparatus 10a transmits the selected link information to the message service providing apparatus 20 in step S1115.

The message service providing apparatus 20 confirms the link information received from the first terminal apparatus 10a in step S1117 step and searches for the attached file corresponding to the link information in step S1119. Also, the message service providing apparatus 20 transmits the searched attached file to the first terminal apparatus 10a in step S1121.

When the attached file is received, the first terminal apparatus 10a outputs the received attached file in step S1123.

Thus, in the present invention, since the listed link information of the attached file is selected to access the attached file without scrolling through a conversation window during messenger service to search for and execute the attached file, the attached file can be easily confirmed. Further, since the attached files received during a conversation using the messenger service are classified in conversation units or conversation partner units and stored, management of the attached files can be effectively performed.

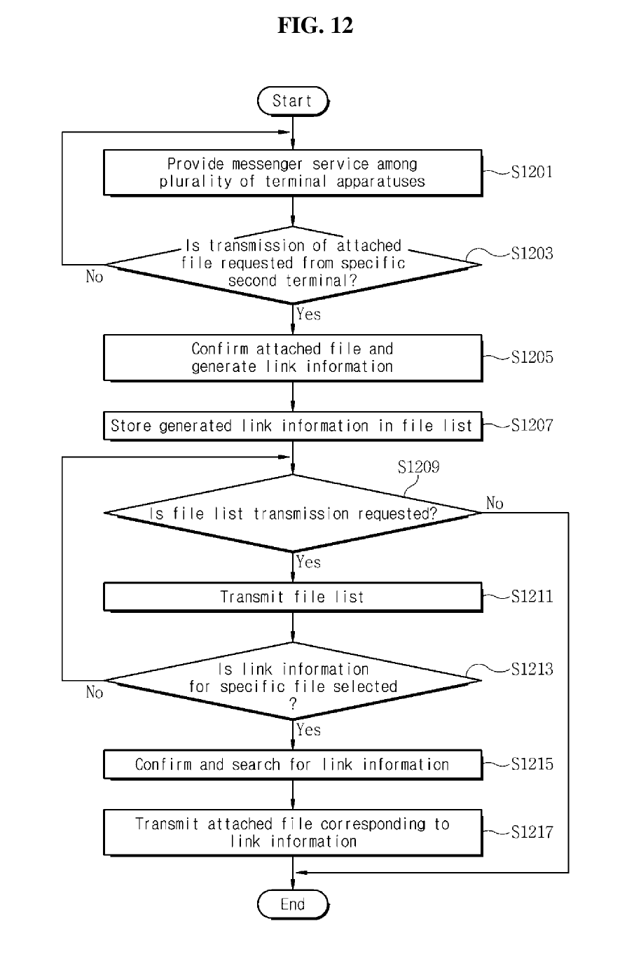

FIG. 12 is a flowchart illustrating operation of the service apparatus according to an embodiment of the present invention.

Referring to FIG. 12, the message service providing apparatus 20 according to the present invention provides a messenger service executed among a plurality of terminal apparatuses in step S1201. Also, the message service providing apparatus 20 determines whether transmission of the attached file is requested from the second terminal apparatus 10b while providing the messenger service in step S1203. Here, the attached file includes a document file, a music file, a video file, URL information or the like received from the partner terminal.

When the transmission of the attached file is requested, the message service providing apparatus 20 confirms the attached file requested for transmission and generates link information related thereto in step S1205. Here, the link information includes information such as a file name, a file size, an extension and a file format of the attached file to identify the attached file. On the other hand, when the transmission of the attached file is not requested, the message service providing apparatus 20 continues the messenger service.

The message service providing apparatus 20 stores the link information in a file list in step S1207. In this case, the message service providing apparatus 20 compresses the received attached file, classifies the attached file in conversation units or conversation partner units for the messenger service and stores the compressed attached file and the link information to be matched according to the classification unit.

The message service providing apparatus 20 determines whether file list transmission for attached file reception is requested from the first terminal apparatus 10a executing messenger service in step S1209. When the file list transmission is requested, the message service providing apparatus 20 transmits the previously stored file list to the first terminal apparatus 10a in step S1211. On the other hand, when the file list transmission is not requested, the message service providing apparatus 20 continues the messenger service.

The message service providing apparatus 20 then determines whether the link information included in the file list is selected by the selection of the first terminal apparatus 10a in step S1213. When the link information for the specific file is selected, the message service providing apparatus 20 confirms the link information received from the first terminal apparatus 10a and searches for the attached file corresponding to the confirmed link information in step S1215. Also, the message service providing apparatus 20 transmits the searched attached file to the first terminal apparatus 10a in step S1217.

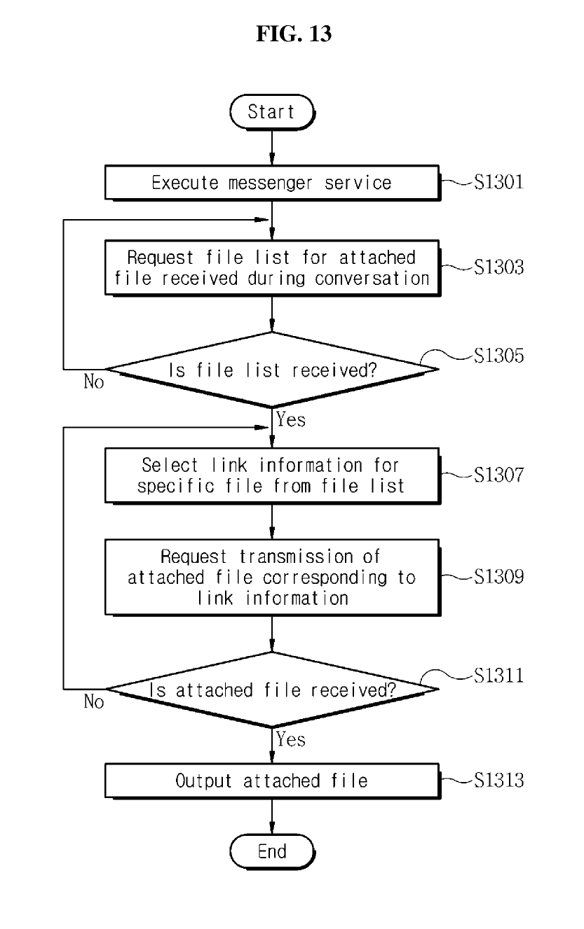

FIG. 13 is a flowchart illustrating operation of the terminal according to an embodiment of the present invention.

Referring to FIG. 13, the first terminal apparatus 10a according to the present invention executes the messenger service with the second terminal apparatus 10b through the message service providing apparatus 20 in step S1301.

The first terminal apparatus 10a requests the message service providing apparatus 20 to provide the file list for the received attached file during use of the messenger service in step S1303. Here, the attached file includes a document file, a music file, a video file, URL information or the like received from the partner terminal. The first terminal apparatus 10a determines whether the file list is received from the message service providing apparatus 20 in response to the request of the file list in step S1305.

When the file list is received, the first terminal apparatus 10a selects the link information for a specific file from the received file list in step S1307. Here, the link information includes information such as a file name, a file size, an extension and a file format of the attached file to identify the attached file. Also, the first terminal apparatus 10a transmits the selected link information to the message service providing apparatus 20 and requests transmission of the attached file in step S1309.

The first terminal 10a confirms whether the attached file is received from the message service providing apparatus 20 in step S1311. When the attached file is received, the first terminal apparatus 10a outputs the received attached file in step S1313. On the other hand, when the attached file is not received, the first terminal 10a selects the link information for the specific file in the file list again and requests the message service providing apparatus 20 to transmit the corresponding attached file again.

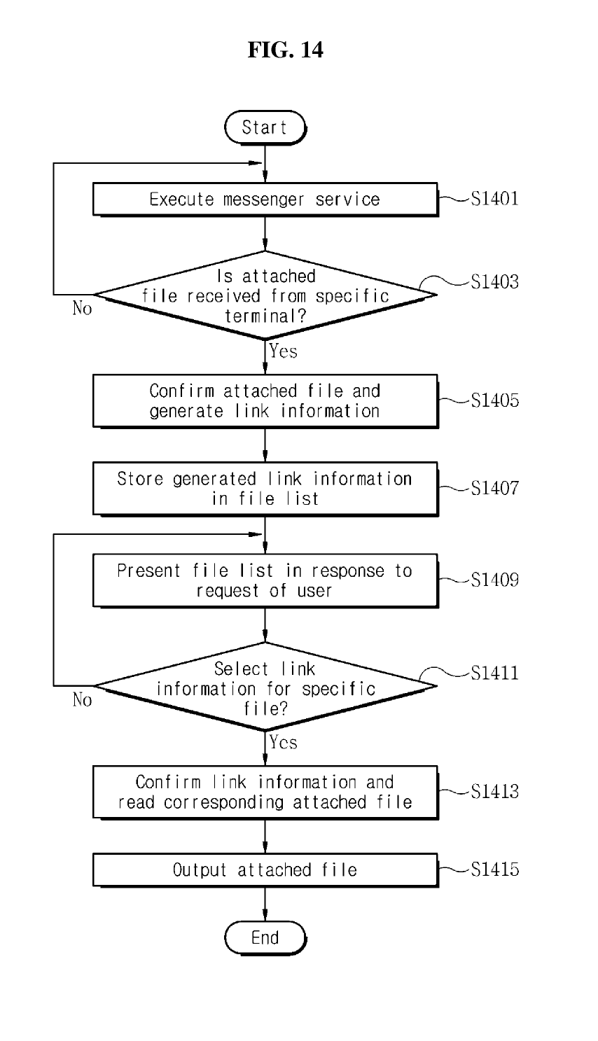

FIG. 14 is a flowchart illustrating operation of a terminal according to another embodiment of the present invention.

Referring to FIG. 14, the first terminal 10a according to the present invention executes the messenger service with the second terminal 10b through the message service providing apparatus 20 in step S1401. During the execution of the messenger service, the first terminal 10a confirms whether the attached file is received from the second terminal apparatus 10b in step S1403. Here, the attached file includes a document file, a music file, a video file, URL information or the like received from the partner terminal.

When the attached file is received, the first terminal apparatus 10a confirms the attached file and generates link information for this in step S1405. In other words, the first terminal apparatus 10a confirms information such as a file name, a file size, an extension and a file format of the attached file to identify the received attached file. The first terminal 10a then stores the link information in the file list in step S1407. The first terminal apparatus 10a compresses the received attached file, classifies the attached file in conversation units or conversation partner units for the messenger service, and stores the compressed attached file and the link information to be matched according to the classification unit.

The first terminal 10a presents the file list in response to the request of the user in step S1409. Also, the first terminal 10a confirms whether the link information for a specific file is selected in step S1411. When the link information is selected, the first terminal 10a confirms the link information and reads the attached file in step S1413. In other words, the first terminal apparatus 10a searches for the attached file corresponding to the link information, and extracts the related attached file according to a search result. Also, the first terminal apparatus 10a outputs the attached file in step S1415.

Next, a method of analyzing content of a message according to an embodiment of the present invention will be described.

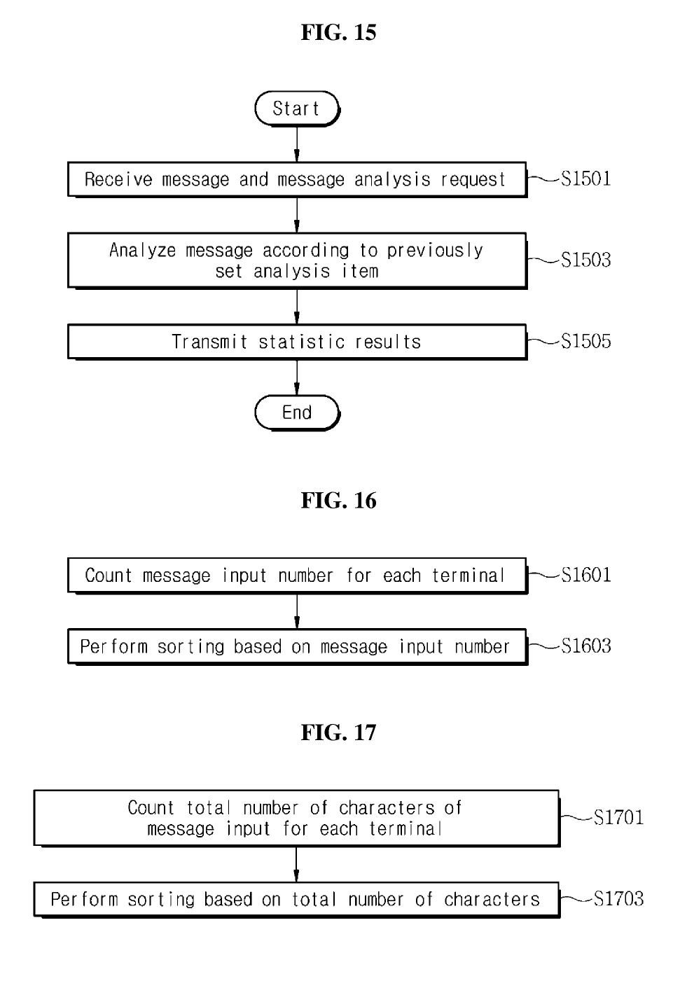

FIG. 15 is schematic flowchart illustrating a message service providing method according to an embodiment of the present invention.

An example in which the message service providing apparatus 20 analyzes the content of the message in response to a request of any one of a plurality of terminals participating in a conversation channel and provides an analysis result to the terminal requesting the message analysis will be described, but a terminal participating in the conversation channel may directly analyze a message and provide an analysis result to the user.

Hereinafter, a first terminal apparatus, one or more second terminal apparatuses, and a third terminal apparatus transmit or receive a message through the conversation channel, and it is assumed that a name of a user of the first terminal apparatus is A, a name of a user of the second terminal apparatus is B, and a name of a user of the third terminal apparatus is C. It is assumed that, in this state, the user of the first terminal apparatus requests the message service providing apparatus 20 to analyze content of messages transmitted or received to date.

Hereinafter, the message service providing method will be described with reference to FIGS. 1 and 15. First, the message service providing apparatus 20 monitors and receives a message transmitted or received through one or more conversation channels and receives a message analysis request from any one terminal, for example, the first terminal apparatus participating in the conversation channel (S1501).

Then, the message service providing apparatus 20 analyzes the message according to the previously set analysis item (S1503). Here, the previously set analysis item refers to any one of the number of times a message is input for each terminal, a total number of characters, popularity, kindness, and a primary keyword as described above. The message service providing apparatus 20 analyzes the message transmitted or received through the conversation channel to date based on the previously set analysis items.

Then, various statistic results are calculated based on the analysis result, and the statistic results are transmitted to the terminal requesting provision of the message service, e.g., the first terminal apparatus (S1505).

Step S1503 will be described in greater detail with reference to FIGS. 16 to 22.

First, a method of providing a message service when the message analysis item is the number of times a message is input for each terminal will be described.

FIG. 16 is a flowchart of a method of analyzing content of a message when the message analysis item is the number of times a message is input for each terminal.

Referring to FIGS. 1 and 16, when the message analysis item is the number of times a message is input for each terminal, first, the message service providing apparatus 20 extracts a message transmitted or received through the conversation channel to date for each terminal, and counts the message input number for each terminal (S1601). As illustrated in FIG. 21, A, which is the first terminal apparatus, has input a total of three messages to date, B, which is the second terminal apparatus, has input a total of one message, and C, which is the third terminal apparatus, has input a total of one message, and the message service providing apparatus 20 performs sorting based on the number of times a message is input for each terminal (S1603) and calculate statistics.

For example, statistics for the user A who has input the most messages and the users B and C who have input the least messages are calculated and transmitted to the user A of the terminal requesting the message analysis, i.e., the first terminal.

Hereinafter, a method of providing a message service when the message analysis item is the total number of characters will be described.

FIG. 17 is a flowchart of a method of analyzing content of a message when the message analysis item is the total number of characters.

Referring to FIGS. 1 and 17, the message service providing apparatus 20 extracts messages transmitted or received through the conversation channel to date for each terminal and counts the total number of characters in the message input for each terminal (S1701). For example, as illustrated in FIG. 21, when A, which is the first terminal apparatus, inputs 26 characters in total in the three messages, B, which is the second terminal apparatus, inputs 37 characters in total in one message, and C, which is the third terminal apparatus, inputs nine characters in total in one message, the message service providing apparatus 20 counts the total number of characters of the messages input by the respective terminals, performs sorting based on the total number of characters (S1703), and calculates statistics for this.

For example, the message service providing apparatus 20 may calculate statistics for the user who speaks the most (B) and the user who speaks the least (C), and transmit the statistics to user A of the first terminal.

Hereinafter, the message service providing method when the message analysis item is the popularity will be described.

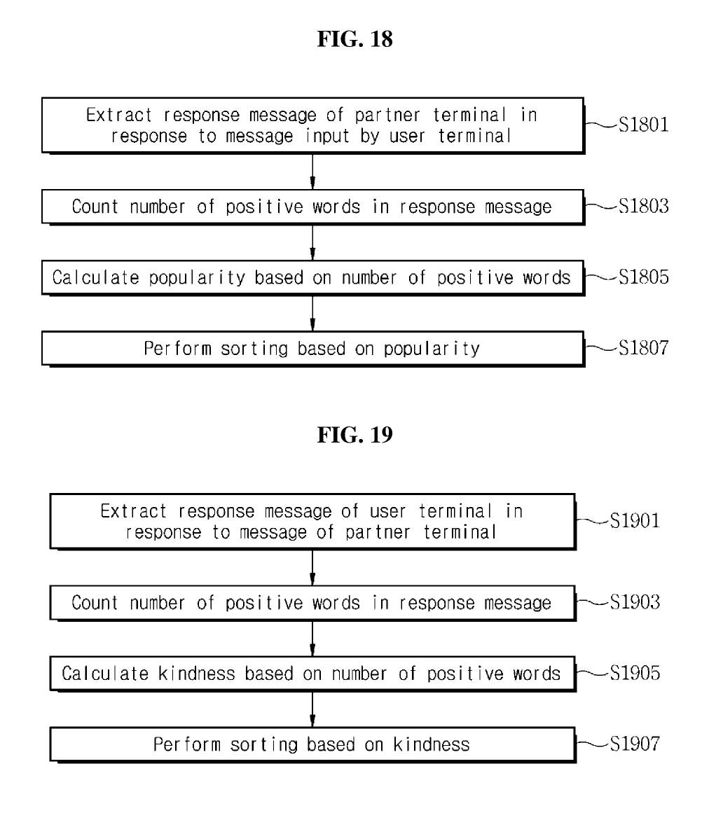

FIG. 18 is a flowchart of a method of analyzing content of a message when a message analysis item is the popularity.

Referring to FIGS. 1 and 18, the message service providing apparatus 20 extracts a response message of a partner in response to a message input by each terminal from messages transmitted or received through the conversation channel to date (S1801).

Here, the response message is a message of a partner terminal apparatus input within a certain period of time in response to a message lastly input by any one terminal apparatus connected to the conversation channel. Here, the certain period may be 1 second, 3 seconds or a period in which a first message of the partner in response to the message input by the specific terminal can be extracted as the response message

For example, a response message (“Great job son. Well done, son. Really good. You see, son. You can do anything if you put your mind to it.) input by the second terminal apparatus and a response message (“So is that it!”) input by the third terminal apparatus after a last message (“I got a 60 in mathematics”) input by A, which is the first terminal apparatus, are extracted, as illustrated in FIG. 10.

Then, the number of positive words in the extracted response message is counted (S1803).

For example, when the popularity of the message input by A, which is the first terminal apparatus, to date is to be calculated, the response message of B, which is the second terminal apparatus, and the response message of C, which is the third terminal apparatus, in response to the input message of A, which is the first terminal apparatus, are calculated, and the number of positive words in the calculated response messages is counted.

Here, the positive word may be set by the message service providing apparatus 20 or the terminal requesting the message analysis. In the above example, previously set positive words are assumed to be “great” and “good.”

Then, the message service providing apparatus 20 counts the number of previously set positive words in the response messages of the second terminal apparatus and the third terminal apparatus in response to the input message of the first terminal apparatus, and calculates the popularity based on the counted number of positive words (S1805).

For example, if the number of positive words of the second terminal apparatus is 3 and the number of the positive words of the third terminal apparatus is 0, the total number of positive words in response to the input message of the first terminal apparatus 10a is 3.

In this way, a total number of positive words of the response messages of the first terminal apparatus and the third terminal apparatus in response to an input message of the second terminal apparatus is counted, a total number of positive words of the response messages of the first terminal apparatus and the second terminal apparatus in response to an input message of the third terminal apparatus is counted, the total numbers of positive words for the respective terminals are compared to calculate the popularity (S1805) and sorting is performed based on the calculated popularity (S1807).

Through such a process, the popularity for the input message of the first terminal apparatus can be calculated to be highest. In addition, a critical value may be set and the number of positive words equal to or more than 5 may be determined to be high popularity.

Hereinafter, a message service providing method when the message analysis item is the kindness will be described.

FIG. 19 is a flowchart of a method of analyzing content of a message when the message analysis item is the kindness.

Here, the kindness refers to an index indicating how many positive messages have been transmitted in response to a message input by a partner. This will be described with reference to FIGS. 1 and 19. First, a response message of a user in response to the input message of the partner is extracted (S1901).

For example, as illustrated in FIG. 21, a response message of B which is the second terminal apparatus in response to the input message of the partner, i.e., an input message of A, which is the first terminal apparatus, is extracted, and the number of positive words in the extracted response message is counted (S1903). The kindness is calculated based on the counted number of positive words (S1905). Then, sorting is performed based on the kindness, and various pieces of statistics information, such as the most friendly user B and the least friendly user C, is provided to the first terminal apparatus.

Hereinafter, the message service providing method when the message analysis item is the primary keyword will be described.

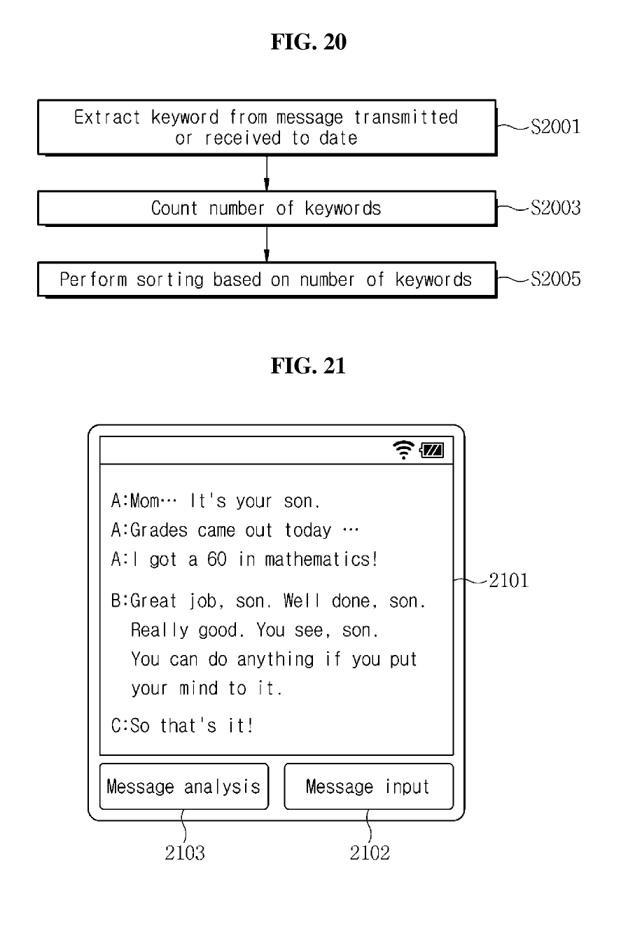

FIG. 20 is a flowchart of a method of analyzing content of a message when the message analysis item is the primary keyword.

Referring to FIGS. 1 and 20, the message service providing apparatus 20 extracts a keyword from a message transmitted or received to date (S2001). Here, the keyword may be a word, the messages transmitted or received to date are parsed to extract words, and the extracted words are counted.

Since a parsing process based on a message is well-known technology, a concrete description is omitted.

Then, the number of extracted words is counted for each word (S2003), and sorting is performed based on the number (S2005).

For example, in the example illustrated in FIG. 21, the keyword that appears the most is “son.” Thus, the keyword that appears the most in the messages transmitted or received to date is analyzed, and a topic of conversation (a conversation related to a son) among users participating in the current conversation channel can be schematically recognized even in late participation in the conversation channel.

Thus, the message service providing apparatus 20 of the present invention analyzes the messages transmitted or received through the conversation channel to date from various points of view and provides the analysis result to the user. Accordingly, there is an advantage that the user participating in the conversation can more easily recognize the atmosphere of the current conversation channel, a user leading the conversation channel, and primary conversation content.

Hereinafter, a user interface which supports user input for providing the message service will be schematically described.

FIGS. 21 and 22 are illustrative diagrams of a user interface illustrating the message service providing method according to an embodiment of the present invention.

As illustrated in FIGS. 21 and 22, serial number 2101 is a message display window in which messages transmitted or received through one conversation channel between terminals to date are listed over time, serial number 2101 is a message analysis button for supporting an input to request the message service providing apparatus 20 to analyze the messages transmitted or received to date in the current conversation channel, and serial number 2102 is a message input button for supporting input of a message.

Here, when the message analysis button 2103 is pressed, previously set analysis items, such as a message input number 2104, a total character number 2105, popularity 2106, kindness 2107, and primary keyword 2108, are displayed, as illustrated in FIG. 22. When a user selects a specific analysis item from among the analysis items, a statistic result is displayed on the message display window.

According to the message service providing method of the present invention, there is an advantage that messages transmitted or received among a plurality of users are clearly provided according to the analysis items such that content of the conversation made to date can be confirmed more easily.

Further, there is an advantage that a late participant in the conversation can more easily recognize the content of the previous conversation of users, the atmosphere or the like.

In this embodiment of the present invention, the analysis items have been described based on the number of times a message is input, the total number of characters, the popularity, the kindness, and the primary keyword as described above, but the present invention is not limited thereto, and a message transmitted or received through one conversation channel may be analyzed from various points of view.

Further, messages input by one terminal in various conversation channels in which the terminal participates, as well as one conversation channel may be collected and analyzed and a result can be provided to the terminal.

Meanwhile, a method of providing comment information according to an embodiment of the present invention will be described hereinafter.

FIG. 23 is a diagram illustrating an example of a method of operating the message service providing apparatus 20 in the comment information providing method according to an embodiment of the present invention.

Referring to FIG. 23, first, the message service providing apparatus 20 supports a message service in step S2301. For this, the message service providing apparatus 20 may support connection of the terminal apparatuses 10 and transfer a message according to a message transmission and reception request between the terminal apparatuses 10. In addition, the message service providing apparatus 20 confirms whether there is reception of a term for which comment information is to be provided in step S2303. In other words, the message service providing apparatus 20 confirms whether a comment information providing request message for the specific term is received from a specific terminal apparatus 10. When the comment information providing request message is not received in this step, the message service providing apparatus 20 may skip to step S2315. In another embodiment of the present invention, step S2303 described above may be omitted, a term may be automatically extracted for the message transmitted between the terminal apparatuses 10, and the following step S2305 may be performed.

On the other hand, when the comment information providing request message for the term is received in step S2303, the message service providing apparatus 20 branches to step S2305 to perform term search in the comment information DB 23c. Also, in step S2307, the message service providing apparatus 20 confirms whether the requested term is registered in the comment information DB 23c. When there is no term to be searched for in the comment information DB 23c in this step, the message service providing apparatus 20 branches to step S2309 to perform extended term search. In other words, the message service providing apparatus 20 connects to the specific service apparatus in which the comment information of the term can be searched, such as specific service apparatuses designated by a manager or randomly selected, e.g., a community service apparatus, a Web blog service apparatus, or a search service apparatus. Also, the message service providing apparatus 20 may collect a description or a definition corresponding to the term for which comment information providing is requested by terminal apparatus 10 or a sentence or a question and answer including the term.

On the other hand, when there is a term to be searched for in the comment database in step S2307, the message service providing apparatus 20 branches to step S2311 to collect the comment information of the term. When a plurality of terms of different categories are searched for in this process, the message service providing apparatus 20 may select all of the searched terms or select a specific term. For selection of the specific term, the message service providing apparatus 20 may confirm whether there are other terms included in the comment information providing request message or whether there is a sentence including the term to be searched for. Also, when there are words or terms other than the term to be searched for in the comment information providing request message, the message service providing apparatus 20 can perform category classification based on the words or terms. In this case, the message service providing apparatus 20 may perform search of the comment information DB 23c for terms mapped with the other words or terms for category classification.

Further, in step S2305, the message service providing apparatus 20 may compare personal information of a sender and a recipient of the message to confirm a difference in culture, and search for the comment information from the comment information DB 23c based on the difference in culture. As illustrated above, if the message sender is a man in his teens and the message recipient is a woman in her 30s, the comment information of the term is collected according to an item in which there is the difference in culture between the message sender and the message recipient, i.e., according to an age.

When the requested comment information of the term is collected, the message service providing apparatus 20 provides the collected comment information to the terminal apparatus 10 in step S2313. In this case, the message service providing apparatus 20 may provide the requested term and comment information together. Further, the message service providing apparatus 20 may confirm whether the message service ends in step S2315 and support the termination of the message service when an event for message service termination occurs. When a separate event for message service termination does not occur, the message service providing apparatus 20 branches to the previous steps to provide the comment information service while supporting the message service.

Meanwhile, although the case in which the message service providing apparatus 20 performs the comment information providing service while supporting the message service has been described in the description above, the present invention is limited thereto. In other words, the message service providing apparatus 20 may include only an apparatus for an information providing service, and may provide corresponding comment information upon receiving the comment information providing request message for the specific term included in the message from the specific terminal apparatus 10.

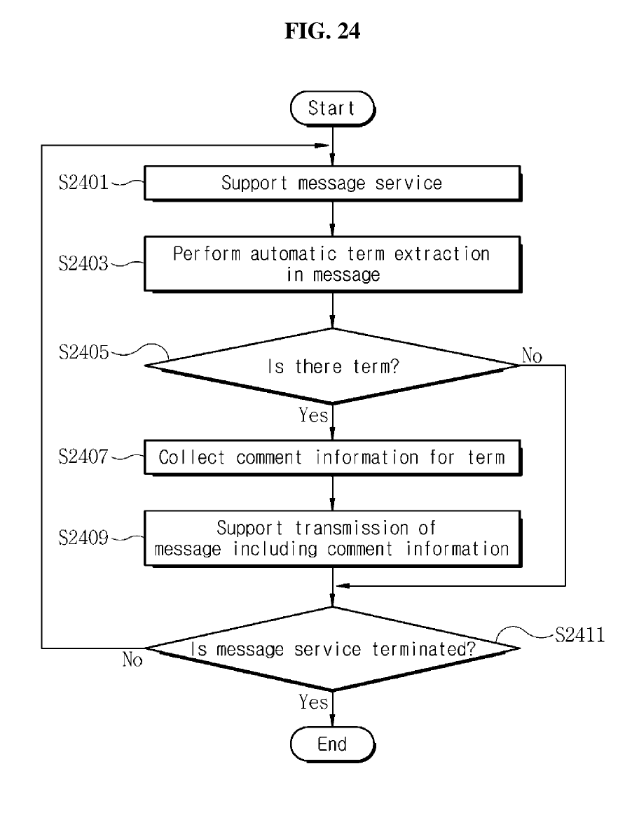

FIG. 24 is a diagram illustrating another example of operation of the message service providing apparatus 20 in the comment information providing method according to an embodiment of the present invention.

Referring to FIG. 24, in a method of operating the information providing service apparatus of the present invention, the message service providing apparatus 20 first performs message service support in step S2401. In other words, the message service providing apparatus 20 may perform support of transmission of an SMS message, a chat message, or an E-mail message produced by the specific terminal apparatus 10 to the other terminal apparatus in response to the request of the specific terminal apparatus 10. In this case, when a terminal apparatus to receive the message is a terminal in which an automatic comment information providing mode is set, the message service providing apparatus 20 performs automatic term extraction in the message transmitted or received in step S2403. In other words, the message service providing apparatus 20 extracts a word or a term from the sentences described in the message. On the other hand, when the terminal to receive the message is a terminal in which the automatic mode is not set, the message service providing apparatus 20 may perform only message service support.

Then, the message service providing apparatus 20 confirms whether there is the extracted term in the comment information DB 23c in step S2405. When there is the extracted term in the comment information DB 23c, the message service providing apparatus 20 branches to step S2407 to collect the comment information for the term. When the comment information is collected, the message service providing apparatus 20 includes the collected comment information in a message to be transmitted, and support transmission of the message including the comment information to the terminal apparatus 10 in step S2409. On the other hand, when there is no extracted term in the comment information DB 23c, the message service providing apparatus 20 may not record separate comment information.

Then, the message service providing apparatus 20 can perform the message service termination of the present invention when a message service termination event occurs in step S2411. When there is no occurrence of an event for message service termination, the message service providing apparatus 20 may branch to the previous steps to perform support of the comment information providing service.

In the description above, the step of confirming whether there is the term included in the message for which the comment information is to be provided in the comment information DB 23c may include a category classification step and a classified category-based term search step. This will be described in greater detail. The message service providing apparatus 20 extracts terms in the message. An extraction criterion may be a word having a certain meaning, a term separated by a space, a sentence separated by a period or a specific term, or the like. Meanwhile, when a term having a higher frequency than a specific number is detected for the extracted term, the message service providing apparatus 20 may distinguish a category based on the term. Or, the message service providing apparatus 20 may apply the specific term as well as neighboring terms described together with the specific term to the category classification. Here, the message service providing apparatus 20 may gradually perform the category classification using the extracted specific term and neighboring terms of the specific term. For example, the message service providing apparatus 20 may classify terms of a certain number of times or more included in the message or terms extracted according to a previously set specific criterion. Also, the message service providing apparatus 20 may detect a category corresponding to an upper category in the comment information DB 23c. Further, the message service providing apparatus 20 may detect a lower category corresponding to neighboring terms extracted together with the specific term in the detected category.

Meanwhile, in the process of performing the automatic mode in the method of operating the message service providing apparatus 20, the comment information of the term which is not included in the comment information DB 23c may not be provided. In this case, the terminal apparatus 10 receiving the message including the comment information may select a specific term according to a user manipulation and request the message service providing apparatus 20 to provide the comment information of the corresponding term. In other words, the message service providing apparatus 20 may automatically provide the comment information for the terms included in the specific message based on the automatic mode according to the setting of the terminal apparatus 10, and support operation of the manual mode in response to the request of the terminal apparatus 10 receiving the message including the comment information.

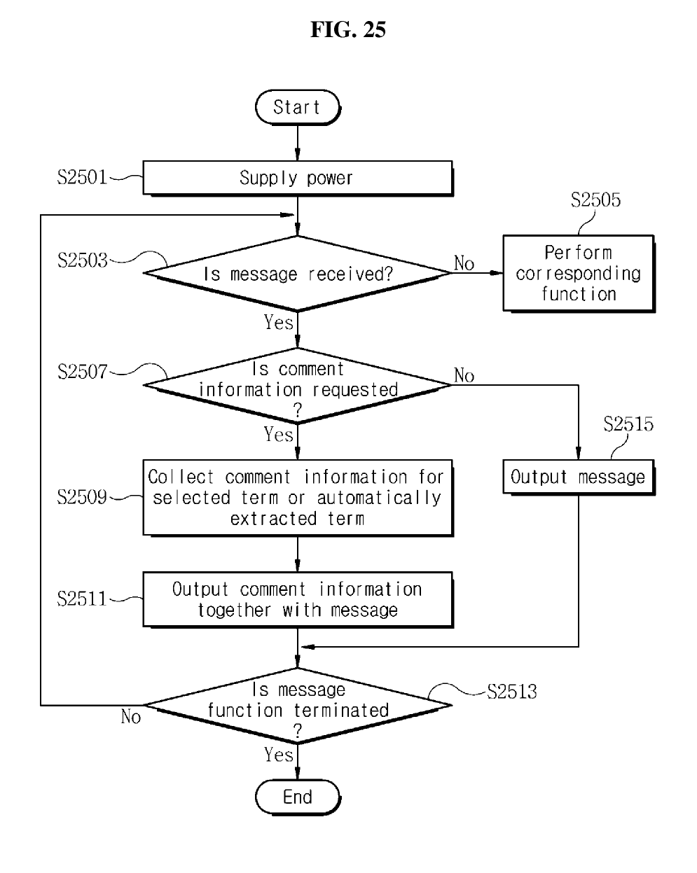

FIG. 25 is a diagram illustrating a terminal operation in the comment information providing method of the present invention.

Referring to FIG. 25, the control unit 12 of the terminal apparatus 10 may supply power necessary for a configuration of the terminal apparatus 10 using power provided from a power supply unit in step S2501. Then, when a specific event occurs, the control unit 12 confirms whether the event is an event for reception of a message in step S2503. When the event is not the event for message reception, the control unit 12 branches to step S2505 to support function execution according to the event. For example, the control unit 12 may support execution of a call function, execution of a file reproduction function, or the like.

On the other hand, when the event occurring in step S2503 is the event for message reception, the control unit 12 supports output of the received message to the display unit 15. Also, the control unit 12 confirms whether there is a request of comment information for a specific term of the message received in step S2507. For this, the user may generate an input signal for selecting a term requiring comment information from among specific terms included in content of the message. Meanwhile, when the comment information providing service is set to be provided automatically, the control unit 12 may confirm whether there are terms corresponding to the terms included in the comment information database stored in the storage unit 14 among the terms included in the message. When there are terms registered in the comment information database in the message, the control unit 12 may control output so that the terms are distinguished from other terms.

Also, the control unit 12 collects comment information of a term selected by the user or an automatically extracted term in step S2509. The control unit 12 may perform the collection based on the comment information database stored in the storage unit 14.

When the comment information is collected, the control unit 12 may perform control so that the comment information is output on the screen on which the message is output in step S2511. In this step, the control unit 12 performs support so that the comment information is output in a screen area adjacent to the corresponding term or a separate screen area or output through a separate popup window. The control unit 12 then confirms whether an event for the message function termination occurs in step S2513. Also, when there is no occurrence of an event for message function termination, the control unit 12 may branch to step S2503 to perform the process again.

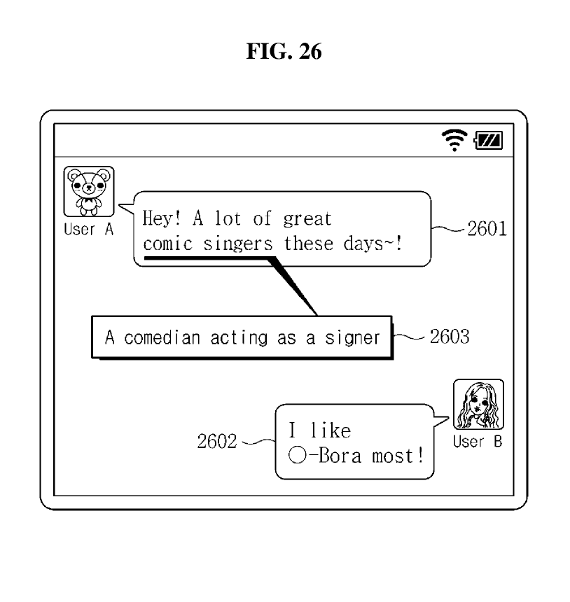

FIG. 26 is a diagram illustrating an example of a screen interface used for comment information providing service according to an embodiment of the present invention.

Referring to FIG. 26, the terminal apparatus 10 may output a message transmission and reception screen to the display unit 15 as shown according to a message service operation. In this case, the provided screen of the display unit 15 may be a chat service screen or an SMS message transmission and reception screen. Further, although not shown, the screen shown in FIG. 26 may be one of various screens related to the message service.

The terminal apparatus 10 outputs a received message 2601 and a transmitted message 2602. In this case, the terminal apparatus 10 may output the comment information 2603 for a term selected by a user and a term extracted automatically among the terms included in the received message 2601. The comment information 2603 output by the display unit 15 may be information detected in the comment information database stored in the storage unit 14 or comment information provided by the message service providing apparatus 20.

The comment information 2603 is also shown to be output on one side of the transmitted message 2602, but the output of the comment information 2603 of the transmitted message 2602 may be omitted.

Meanwhile, in the description above, a target for which the comment information is provided has been described to be the term including meaningful words described in a text, but the present invention is not limited thereto. In other words, the target for which the comment information is provided in the present invention may be any element that may be included in a transmitted or received message, such as any form which is a combination of at least two of an emoticon, an abbreviation, a specific icon, a specific image, a special character and various elements described above.

For this, the comment information DB 23c stored in the message service providing apparatus 20 or the terminal apparatus 10 may include a description, a definition or an example sentence or a question and answer corresponding to the emoticon, the abbreviation, the specific icon, the specific image, the special character or the like described above, and may provide the comment information for a corresponding element based on this. For the comment information database stored in the terminal, updating of the information may be performed through a periodical connection with the information providing service apparatus.

The message service providing method according to an embodiment of the present invention has been described above.

A processor mounted on the terminal apparatus 10 and the message service providing apparatus 20 according to an embodiment of the present invention may process a program instruction for executing the method according to the present invention. In an implementation, this processor may be a single-threaded processor, and in other implementations, the present processor may be a multithreaded processor. Furthermore, the present processor can process instructions stored on a memory or a storage device.

Further, computer programs mounted on the apparatus according to the present invention and executing the method according to the present invention (also known as a program, software, a software application, a script or a code), for example, various programs for setting the message service providing function, may be produced using any type of programming language, including a compiled or interpreted language or a priori or procedure-oriented language, and may be developed in any form, including a stand-alone program or module, a component, a subroutine or other units suitable for being used in a computer environment. The computer program does not necessarily correspond to a file of a file system. The program may be stored in a single file provided in a requested program, in a plurality of interacting files (e.g., files which store one or more modules, a subprogram or some codes), or in a part of a file holding other programs and data (e.g., one or more scripts stored in a markup language document). The computer program may be located at one site and distributed over a plurality of sites, and developed to be executed on a plurality of computers interconnected by a communication network or on a single computer.

Further, a computer-readable medium suitable for storing computer program instructions and data includes any type of non-volatile memory, medium and memory device, including a semiconductor memory device such as an EPROM, an EEPROM and a flash memory device, a magnetic disk such as an internal hard disk or an external disk, a magnetic-optical disc, a CD-ROM and a DVD-ROM. The processor and the memory may be supplemented by or integrated with a special-purpose logic circuit.

Thus, the present disclosure includes the details of a plurality of specific implementations, but these should not be understood as limiting the invention or anything which can be claimed, but rather should be understood as descriptions of characteristics specific to specific embodiments of this specific invention. The specific characteristics described in this disclosure in the context of the individual embodiments may be implemented in combination in a single embodiment. On the other hand, various characteristics described in the context of the single embodiment may be implemented individually or in any appropriate sub-combination in a plurality of embodiments. Furthermore, the characteristics may operate in a specific combination and be described as initially claimed in such a way, but one or more characteristics from the claimed combination may be excluded from the combination in some cases, and the claimed combination may be changed into a sub-combination or a variant of the sub-combination.

Similarly, while the operations are described in a specific order in the drawings, it should not be understood that such operations or all shown operations should be performed in the specific shown order or in a sequential order in order to obtain the preferred results. In specific cases, multitasking and parallel processing may be advantageous. Further, it should not be understood that separation of various system components in the above-described embodiments is required in all the embodiments, and it should be understood that the described program components and systems may be integrated with a single general software product or packaged into a multi-software product.

In this disclosure, the described subjects, i.e., the specific embodiments of the message service providing method, have mainly been described above. Other embodiments are included within the following claims. For example, operations cited in the claims can achieve preferred results while being performed in a different order. For example, the process illustrated in the attached drawings does not necessarily require the specific order or sequential order in order to obtain the preferred results. In a particular implementation, multitasking and parallel processing may be advantageous.

Further, the description of this technology presents best modes of the present invention, and provides examples for explaining the present invention and allowing those skilled in the art to manufacture or use the present invention. The disclosure described in this way does not limit the present invention to the present concrete terms. Therefore, while the present invention has been described in detail with reference to the examples described above, those skilled in the art may make alternations, changes, and variations to the examples without departing from the scope of the present invention.

Accordingly, the scope of the present invention is not defined by the described embodiments but must be defined by the claims.

### INDUSTRIAL APPLICABILITY

The present invention relates to a message service providing method, and more specifically, to a message service providing method, and an apparatus and a system therefor capable of protecting a user's privacy by extracting a part corresponding to confidential information and setting a protection function for only the extracted part when the confidential information is included in a message received from a partner.

According to the present invention, there is an advantage that selective message protection can be realized by setting the protection function for only the part corresponding to the confidential information when the confidential information is included in the message received from the partner, and accordingly, this can contribute to the development of the message service industry.

In addition, since the present invention can be sufficiently commercially available and can be clearly practically implemented, there is industrial applicability.

1. A message service providing system comprising:
a message service providing apparatus which determines whether confidential information is included in a received message when the message is received from a user terminal apparatus, extracts a part corresponding to the confidential information from the received message when the confidential information is included, sets a protection function for only the extracted part, and transmits the message in which the protection function has been set to a partner terminal apparatus; and
a terminal apparatus which transmits an input message to the message service providing apparatus when the message is input by a user, requests the user to input a password when the message in which the protection function has been set is received from the message service providing apparatus, and releases the protection function to display the message when the password is input by the user and the input password matches a previously set password.

2. A terminal apparatus comprising:
a communication unit which transmits or receives a message; and
a control unit which determines whether confidential information is included in the message, extracts a part corresponding to the confidential information from the message when the confidential information is included, and sets a protection function for only the extracted part.

3. The terminal apparatus according to claim 2, wherein:
when the protection function is set to be applied based on any one of line units, phrase units, and syllable units,
the control unit applies the protection function to a line, a phrase, or a syllable including the extracted part after extracting the part corresponding to the confidential information from the received message.

4. The terminal apparatus according to claim 3, wherein the control unit adjusts shade, color, brightness and screen brightness of an area corresponding to the extracted part or adjusts a size of a character corresponding to the extracted part to set the protection function.

5. The terminal apparatus according to claim 1, wherein the control unit displays the message in which the protection function has been set, displays a password input window through which a password is able to be input by a user in response to a request of the user, and releases the protection function to display the message when the password is input by the user through the password input window and the input password matches a previously set password.

6. A message service providing apparatus comprising:
a service communication unit which transmits or receives information to or from a terminal apparatus; and
a service control unit which determines whether confidential information is included in a received message when the message is received from any one user terminal apparatus, extracts a part corresponding to the confidential information from the received message when the confidential information is included, sets a protection function for only the extracted part, and transmits the message in which the protection function has been set to a partner terminal apparatus.

7. The message service providing apparatus according to claim 6, wherein the service control unit confirms previously set regular information corresponding to the confidential information and extracts an entire part corresponding to the regular information.

8. A message service providing system comprising:
a terminal apparatus which requests a service apparatus to provide a file list for an attached file received from at least one other terminal apparatus during use of a messenger service, receives the file list from the service apparatus according to the request, selects an attached file from the received file list, requests the service apparatus to transmit the selected attached file, receives the attached file according to the request, and outputs the received attached file; and
a message service providing apparatus which provides a messenger service among a plurality of terminal apparatuses, confirms an attached file transmitted from at least one terminal apparatus using the messenger service, generates link information related to the confirmed attached file, stores the generated link information in a file list, transmits the file list in response to a request of the terminal apparatus, confirms the link information for the attached file selected from the file list, searches for the attached file corresponding to the confirmed link information, and transmits the attached file to the terminal apparatus.

9. A terminal apparatus comprising:
a communication unit which communicates with a plurality of terminal apparatuses and a message service providing apparatus to transmit or receive data for execution of a messenger service; and
a control unit which performs control to request the message service providing apparatus to provide a file list for at least one attached file received from at least one other terminal apparatus during use of the messenger service, receive the file list from the message service providing apparatus according to the request, select at least one attached file from the received file list, request the message service providing apparatus to transmit the selected attached file, receive the attached file according to the request, and output the received attached file.

10. The terminal apparatus according to claim 9, further comprising a storage unit which stores the attached file received from at least one other terminal apparatus during use of the messenger service, and a file list including link information of the attached file.

11. The terminal apparatus according to claim 9, wherein the control unit receives the attached file from at least one other terminal apparatus during use of the messenger service, generates link information related to the received attached file, stores the generated link information as a file list, presents the file list in response to a request of a user during use of the messenger service, confirms the link information selected from the file list, reads an attached file corresponding to the confirmed link information, and outputs the read attached file.

12. The terminal apparatus according to claim 9, wherein the control unit outputs information for the attached file in a partial area or a previously set screen position of the messenger service execution screen.

13. The terminal apparatus according to claim 12, wherein the control unit displays an attached file menu in response to a request of the user during use of the messenger service, presents a file list for an attached file attached during conversation or previously when the attached file menu is selected, and outputs a specific file selected from the file list.

14. A message service providing apparatus comprising:
a service communication unit which communicates with a plurality of terminal apparatuses to transmit or receive data for providing a messenger service;
a service storage unit which stores an attached file received from at least one terminal apparatus during use of the messenger service, and a file list including link information of the attached file; and
a service control unit which perform control to provide the messenger service among a plurality of terminal apparatuses, confirm an attached file transmitted from at least one terminal apparatus using the messenger service, generate link information related to the confirmed attached file, store the generated link information as a file list, transmit the file list in response to a request of the terminal apparatus, confirm the link information for the attached file selected from the file list, search for the attached file corresponding to the confirmed link information, and output the attached file to the terminal apparatus.

15. The message service providing apparatus according to claim 14, wherein the service control unit compresses the received attached file, classifies the attached file in conversation window units or in conversation partner units, and stores the compressed attached file and the link information to be matched according to the classification unit.

16. The message service providing apparatus according to claim 14, wherein the attached file includes at least one of a document file, a music file, a video file, and URL information received from at least one terminal apparatus during use of the messenger service.

17. The message service providing apparatus according to claim 14, wherein the link information identifies each attached file, and includes at least one piece of information of a file name, a file size, an extension and a file format of the attached file.

18. A message service providing system comprising:
a terminal apparatus which transmits or receives a message in a state in which a conversation channel with at least one partner terminal apparatus is established, requests a message service providing apparatus to analyze a message transmitted or received through the conversation channel, and receives a statistic result for the message from the message service providing apparatus; and
the message service providing apparatus which receives and stores a message transmitted or received through at least one conversation channel, analyzes the message transmitted or received through the conversation channel to date according to previously set analysis items to calculate statistics when an analysis request for a message is received from any one terminal apparatus participating in the conversation channel, and transmits the calculated statistic result to the terminal apparatus.

19. A message service providing system comprising:
one or more terminal apparatuses which transmit or receive a message and output comment information for one or more terms included in the message together with the message; and
a message service providing apparatus which compares personal information of a sender and a recipient of the message to confirm a difference in culture between the sender and the recipient, collects comment information for one or more terms included in the message based on the confirmed culture difference, and provide the collected comment information to the terminal.

20. A message service providing apparatus comprising:
a service communication unit which communicates with one or more terminal apparatuses;
a service storage unit which stores a comment information database which defines one or more meanings of one or more terms; and
a service control unit which performs control to compare personal information of a sender and a recipient of a message transmitted or received by the plurality of terminal apparatuses to confirm a difference in culture between the sender and the recipient, search the comment information database based on the confirmed culture difference to refer to neighboring terms of one or more terms included in the message, confirm a category corresponding to the term, collect comment information corresponding to the category from the comment information database, and provide the collected comment information to the terminal apparatus.

21. The message service providing apparatus according to claim 20, wherein the service control unit collects at least one of a specific term and an adjacent neighboring term in content in which the specific term is arranged from the message content, and collects comment information based on an upper category for the specific term and a lower category of the adjacent terms.
